(19) United States
(12) Patent Application Publication
(10) Pub. No.: US 2026/0355974 A1
(43) Pub. Date: Nov. 12, 2026

(54) CONTROL METHOD FOR SUPPORT ROBOT, SUPPORT ROBOT, ELECTRONIC DEVICE, AND COMPUTER STORAGE MEDIUM

(71) Applicant: TENCENT TECHNOLOGY (SHENZHEN) COMPANY LIMITED, Shenzhen (CN)

(72) Inventors: Lipeng CHEN, Shenzhen (CN); Yu ZHENG, Shenzhen (CN); Wangwei LEE, Shenzhen (CN)

(21) Appl. No.: 19/700,280

(22) Filed: Jun. 7, 2026

Related U.S. Application Data
(63) Continuation of application No. PCT/CN2025/070946, filed on Jan. 7, 2025.

(30) Foreign Application Priority Data
Feb. 2, 2024 (CN) 202410163810.2

(51) Int. Cl. B25J 11/00; B25J 9/16; B25J 13/08

(52) U.S. Cl. CPC B25J 11/009; B25J 9/1653; B25J 9/1676; B25J 9/1679; B25J 9/1697; B25J 13/084

(57) ABSTRACT

A control method for a support robot includes: controlling, in response to detecting that a target object has an intention to request support, the support robot to move toward the target object; controlling the mechanical arm to move to a target joint location when the support robot moves to a target movement location, the target movement location and the target joint location both being determined according to relative locations between the target object and the target sensor; and performing compliance control on the support robot when the tactile sensors detect that an external force is applied to the mechanical arm during or after a movement of the mechanical arm to the target joint location.

### RELATED APPLICATIONS

This application is a continuation of PCT Application No. PCT/CN2025/070946, filed on Jan. 7, 2025, which claims priority to Chinese Patent Application No. 202410163810.2 filed on Feb. 2, 2024, which are incorporated in their entirety herein by reference.

### FIELD OF THE TECHNOLOGY

This application relates to the technical field of robots and artificial intelligence, and particularly relates to a control method for a support robot, a support robot, an electronic device, a computer storage medium, and a computer program product.

### BACKGROUND OF THE DISCLOSURE

Mobility assisting devices have been widely applied in various scenes such as daily rehabilitation to enhance users' balance abilities, provide support, and improve stability during their standing or walking. At present, the common mobility assisting devices are crutches or other simple walking aids, and the intelligence level of such devices needs to be improved.

### SUMMARY

The following is a brief description of a subject described in detail in this application. This brief description is not intended to limit the protection scope of the claims.

Embodiments of this application provide a control method for a support robot, a support robot, an electronic device, a computer storage medium, and a computer program product, such that a support task can be automatically performed, thus improving performance accuracy and efficiency of the support task by the support robot.

One aspect of this application provides a control method for a support robot, performed by the electronic device, the support robot comprising a mechanical arm and a target sensor configured to perform object perception, the mechanical arm being provided with tactile sensors, and the control method comprising: controlling, in response to detecting that a target object has an intention to request support, the support robot to move toward the target object; controlling the mechanical arm to move to a target joint location when the support robot moves to a target movement location, the target movement location and the target joint location both being determined according to relative locations between the target object and the target sensor; and performing compliance control on the support robot when the tactile sensors detect that an external force is applied to the mechanical arm during or after a movement of the mechanical arm to the target joint location.

Another aspect of this application provides a support robot, provided with a control circuit, a mechanical arm, and a target sensor configured to perform object perception, the mechanical arm being provided with tactile sensors; The control circuit being configured to control, in response to detecting that a target object has an intention to request support, the support robot to move toward the target object; control the mechanical arm to move to a target joint location when the support robot moves to a target movement location; and perform compliance control on the support robot when the tactile sensors detect that an external force is applied to the mechanical arm during or after movement of the mechanical arm to the target joint location. The target movement location and the target joint location are determined according to relative locations between the target object and the target sensor.

Another aspect of this application further provides an electronic device, including a memory and a processor, the memory storing a computer program, and the processor, when executing the computer program, implementing the control method for a support robot.

In yet another aspect, an embodiment of this application further provides a non-transitory computer-readable storage medium, having a computer program stored therein, the computer program, when being executed by a processor, implementing the control method for a support robot.

The embodiments of this application have at least the following beneficial effects. In response to detecting that the target object has the intention to request support, a support robot is controlled to move toward the target object, and the mechanical arm is controlled to move to the target joint location when the support robot moves to the target movement location. The target movement location and the target joint location are both changed according to the relative locations between the target object and the target sensor. As such, a state of the target object can be perceived, and a support task can be automatically performed according to the state of the target object. Based on this, compliance control is performed on the mechanical arm when the tactile sensors detect that the external force is applied to the mechanical arm during or after movement of the mechanical arm to the target joint location, such that the mechanical arm can follow a posture of the target object to perform the support task. Thus, comfort level in a process of supporting the target object is improved.

In view of this, the control method provided by this application can perform diversified interaction with the target object, such that the support robot can automatically perform the support task, thus improving performance accuracy and efficiency of the support task by the support robot.

Other features and advantages of this application will be described in the following description, and in part will become apparent from the description or will be learned through practice of this application.

### BRIEF DESCRIPTION OF THE DRAWINGS

The accompanying drawings are used to provide further understanding of technical solutions of this application, constitute a part of the description, are used to explain the technical solutions of this application along with embodiments of this application, and do not constitute a limitation to the technical solutions of this application.

FIG. 1 is a schematic diagram of an implementation environment according to an embodiment of this application.

FIG. 2 is a flowchart of a control method for a support robot according to an embodiment of this application.

FIG. 3 is a schematic diagram of supporting a target object according to an embodiment of this application.

FIG. 4 is a first schematic diagram of detecting that a target object has an intention to request support according to an embodiment of this application.

FIG. 5 is a second schematic diagram of detecting that a target object has an intention to request support according to an embodiment of this application.

FIG. 6 is a third schematic diagram of detecting that a target object has an intention to request support according to an embodiment of this application.

FIG. 7 is a fourth schematic diagram of detecting that a target object has an intention to request support according to an embodiment of this application.

FIG. 8 is a schematic diagram of a location transformation relationship according to an embodiment of this application.

FIG. 9 is a schematic flowchart of performing data processing on pose data measured by a pose sensor according to an embodiment of this application.

FIG. 10 is a schematic diagram of a center location according to an embodiment of this application.

FIG. 11 is a schematic diagram of converting a coordinate system where a joint of a support robot is located to a coordinate system where a tactile unit is located according to an embodiment of this application.

FIG. 12 is a schematic flowchart of compliance control according to an embodiment of this application.

FIG. 13 is a schematic diagram of obstacle avoidance of a support robot according to an embodiment of this application.

FIG. 14 is a first entire schematic flowchart of a control method according to an embodiment of this application.

FIG. 15 is a second entire schematic flowchart of a control method according to an embodiment of this application.

FIG. 16 is a third entire schematic flowchart of a control method according to an embodiment of this application.

FIG. 17 is a first schematic structural diagram of a support robot according to an embodiment of this application.

FIG. 18 is a second schematic structural diagram of a support robot according to an embodiment of this application.

FIG. 19 is a schematic structural diagram of a support robot according to an embodiment of this application from another viewing angle.

FIG. 20 is a schematic diagram of an internal structure of a control cabinet of a support robot according to an embodiment of this application.

FIG. 21 is a schematic diagram of structural connection of a support robot according to an embodiment of this application.

### DESCRIPTION OF EMBODIMENTS

For making objectives, technical solutions and advantages of this application clearer, this application will be further described in detail below in conjunction with accompanying drawings and embodiments. Specific embodiments described herein are merely used to explain this application, and are not used to limit this application.

In various embodiments of this application, when related processing needs to be performed according to data related to a target object characteristic, such as attribute information or an attribute information set of a target object, permission or consent of the target object is first obtained, and acquisition, usage, processing, etc. of the data comply with related laws, regulations, and standards. The target object may be a user. In addition, when the attribute information of the target object needs to be obtained in the embodiment of this application, individual permission or individual consent of the target object is obtained through a pop-up window or by skipping to a confirmation page. After the individual permission or the individual consent of the target object is explicitly obtained, necessary data, related to the target object, configured for enabling the embodiment of this application to operate normally is obtained.

In embodiments of this application, the term “module” or “unit” refers to a computer program having a predetermined function or a part of a computer program, which works together with other relevant parts to achieve a predetermined objective, and may be all or partially implemented through software, hardware (such as a processing circuit or a memory), or a combination thereof. Similarly, one processor (or a plurality of processors or memories) may be configured to implement one or more modules or units. In addition, each module or unit may be a part of an entire module or unit including a function of the module or unit.

For ease of understanding the technical solutions provided in the embodiments of this application, some key terms used in the embodiments of this application are first explained herein.

1) A target sensor refers to an apparatus for detecting and measuring parameters such as a physical quantity, a state, or a location of a particular target or object. This type of sensor is generally integrated into an automatic system, a robot, and various detection devices, to collect and identify target information.

2) A tactile sensor refers to a sensor configured to imitate a tactile function in a robot. The tactile sensors may be classified into a touch sensor, a force-torque sensor, a pressure sensor, a slip sensor, etc.

3) A pose describes a location and a posture of an object (for example, coordinates) in a specified coordinate system. For example, a pose is configured for describing a location and a posture of a robot in a space coordinate system. The location refers to positioning of a rigid body in a space, and the location of the rigid body may be represented by a 3×1 matrix, which is a location of a center of a rigid body coordinate system in a base coordinate system. The posture refers to an orientation of the rigid body in the space, and a posture of the rigid body may be represented by a 3×3 matrix, which is a posture of the rigid body coordinate system in the base coordinate system.

4) A pose sensor refers to a sensor configured to detect and measure a location and a posture of an object in a space. The pose sensor may provide three-dimensional location information (for example, x, y, and z coordinates) and posture information (for example, a pitch angle, a roll angle, and a yaw angle) of an object.

Mobility assisting devices have been widely applied in various scenes such as daily rehabilitation, so as to enhance balance abilities, provide support, and improve stability during standing or walking. At present, the common mobility assisting devices refer to crutches or other simple walking aids, and the intelligence level of such devices needs to be improved.

To solve the problems, embodiments of this application provide a control method for a support robot, a support robot, and an electronic device, such that the support robot can automatically perform a support task, thus improving accuracy and efficiency of the support task by the support robot.

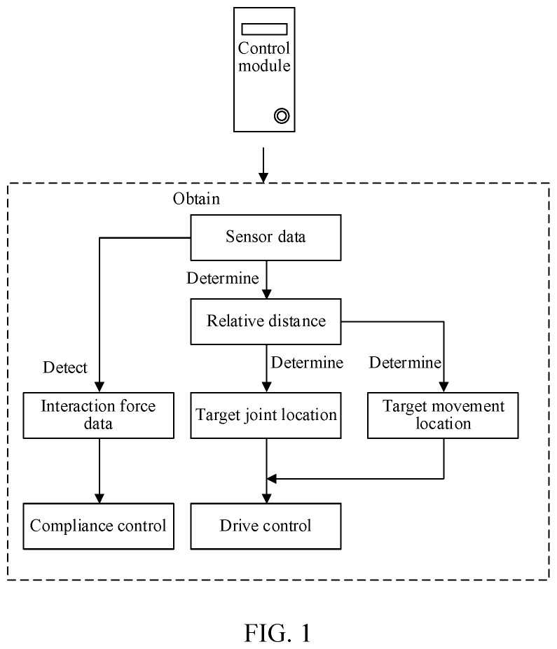

With reference to FIG. 1, FIG. 1 is a schematic diagram of an implementation environment according to an embodiment of this application. The implementation environment includes a control module of a support robot. The control module can be communicatively connected to a sensor arranged on the support robot. After obtaining sensor data of the sensor, the control module may control the support robot to work based on the obtained sensor data.

For example, if the control module identifies from the obtained sensor data that a target object has an intention to request support, the control module may control the support robot to move toward the target object based on the obtained sensor data. A mechanical arm may be controlled to move to a target joint location when the support robot is controlled to move to a target movement location. The target movement location and the target joint location are both changed according to relative locations between the target object and a target sensor. Accordingly, a state of the target object can be perceived, and a support task can be automatically performed according to the state of the target object. Based on this, interaction force data detected by tactile sensors may be obtained when the control module detects that an external force is applied to the mechanical arm where the tactile sensors are located during or after movement of the mechanical arm to the target joint location, and compliance control is performed on the support robot based on the interaction force data. This ensures that the support robot can follow a posture of the target object. Thus, support comfort is improved. In view of this, the control method provided by this application can perform diversified interaction with the target object, such that the support robot can automatically perform a support task, thus improving performance accuracy and efficiency of the support task by the support robot.

In addition, the control module may be in communication with a server, and the server updates an algorithm package corresponding to the control method to the control module in real time.

In some embodiments, the control module is arranged in a terminal device. The terminal device may be arranged on a robot, or the terminal device is connected to a communication module on the robot through a short-range communication technology (for example, ZigBee, Bluetooth, and WIFI) Or, the robot is in wired connection to the terminal device (for example, the robot is provided with a serial communication (COM) interface or a universal serial bus (USB) interface, and a data line is inserted into the interface to be connected to the terminal device).

For example, the sensor arranged on the robot collects environmental information, and transmits the environmental information to the terminal device. The terminal device transmits the environmental information to the server via a network. The server determines a movement control instruction of the robot according to the environmental information of an environment where the robot is located. The server transmits the movement control instruction to the terminal device. The terminal device transmits the movement control instruction to the robot. The robot performs corresponding motion according to the movement control instruction.

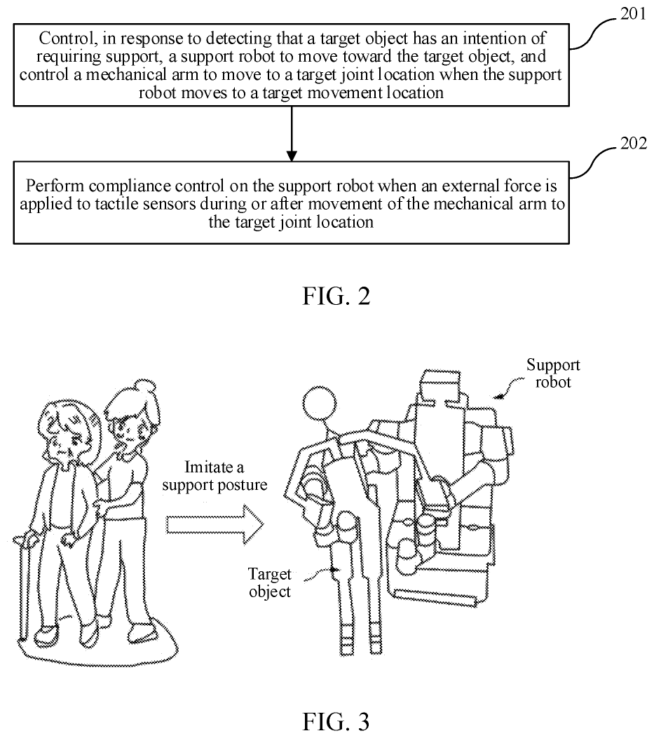

FIG. 2 is a flowchart of a control method for a support robot according to an embodiment of this application. The control method for a support robot may be performed by a control module of the support robot, or through cooperation of a control module of the support robot and a server. In the embodiment of this application, description is made with a case that the control method for a support robot is performed by the control module of the support robot as an example. The control method for a support robot includes, but is not limited to, the following operation 201 and operation 202.

Operation 201: Control, in response to detecting that a target object has an intention to request support, the support robot to move toward the target object, and control a mechanical arm to move to a target joint location when the support robot moves to a target movement location.

In one embodiment, the target object may refer to a user object perceivable by the support robot and having an intention to request support. A support intention may refer to an intention of the target object to obtain support from the support robot. For example, for an object within a computer vision range of the support robot, or an object associated and bound with a terminal through biometric information, the support robot may perceive and identify the target object through a mounted target sensor, and evaluate whether the perceived target object needs to be supported. For the support robot, the support intention of the target object has a plurality of manifestations. For example, the support intention may exist in a mode, such as a voice, a body posture, physical interaction, or a signal instruction. A specific mode may be based on a perception mode provided by the target sensor of the support robot.

In one embodiment, the target movement location is a location within a preset range around the target object, and the preset range may be set according to actual needs of the target object. For example, an arm movement range (a circular zone with an arm span as a diameter and the target object as a center) of the target object is determined according to a height and the arm span of the target object, and the arm movement range is used as a preset range where the target movement location is located.

The target movement location may refer to a location that the support robot needs to reach to complete a task of supporting the target object, and for example, a location closer to the target object having an intention to request support. Or the target movement location may refer to a location of the support robot relative to the target object. The target joint location may refer to a specific posture or joint angle required by the mechanical arm of the support robot to complete the task of supporting the target object. Or the target joint location may refer to a location of the mechanical arm relative to the target object. The target movement location and the target joint location are both changed according to changes in relative locations between the target sensor and the target object. That is, during movement of the support robot toward the target object, a state of the target object may be perceived through the target sensor in real time, and the relative locations between the target sensor and the target object may be corrected. In this way, the target movement location and the target joint location are adjusted in real time. Further, a support task can be automatically adjusted to better match a current state of the target object, and support comfort can be improved.

In one embodiment, in a process of performing the support task of the target object by the support robot, as a state of the target object changes in real time, the target movement location and the target joint location may further be adjusted according to different intentions of requiring support of the target object. For example, the support robot requires different support postures (i.e., target movement locations and target joint locations) when having different support requirements of supporting the target object in walking and supporting the target object in standing. By automatically perceiving the state of the target object and adjusting the target movement location and the target joint location of the support robot in real time, different interaction modes, movement characteristics and support modes are provided to perform diversified interaction with the target object. In this way, the support robot can automatically perform the support task, thus improving performance accuracy and efficiency of the support task by the support robot.

In one embodiment, with reference to FIG. 3, FIG. 3 is a schematic diagram of supporting a target object according to an embodiment of this application. When a support robot needs to support the target object in walking, a target movement location of the support robot may be located at a lateral rear side of the target object. In a supporting process, a state of the target object is perceived in real time, and the target movement location is updated synchronously with movement of the target object, such that the support robot keeps moving toward the target object, and stable relative locations between a target sensor and the target object are maintained. Thus, the support robot can follow the target object to provide support. In addition, a target joint location may be adjusted in real time so as to cause supporting points of a mechanical arm to be maintained at a waist, hips, and wrists of the target object. Thus, a human support posture is imitated to guide a walking direction and maintain a walking rhythm of the target object, so as to improve support comfort.

In one embodiment, when the support robot needs to support the target object in standing, the target movement location of the support robot may be located in front of the target object and fixed relative to the target object, so as to assist the target object in maintaining balance. That is, the support robot moves toward the target object and may remain stable after moving to the target movement location. In a supporting process, the state of the target object is perceived in real time, and the target joint location is adjusted so as to cause supporting points of the mechanical arm to be maintained at an upper body, such as a waist and arms, of the target object, to support a weight of the target object. In this way, the target object changes from a sitting location or a squatting location to a standing location.

In one embodiment, an intention to request support of the target object may be determined by perceiving a state of the target object, i.e., relative locations between the target sensor and the target object. The relative locations between the target object and the target sensor may include relative locations of a center of gravity, a joint location, a torso location, and other locations of the target object with respect to the target sensor. For example, if the center of gravity of the target object is located at a lower location relative to the target sensor and does not move significantly in consecutive frames, it may be determined that the target object is attempting to stand up, thus determining that the target object has an intention to request support to stand. If the center of gravity of the target object changes continuously relative to the target sensor in the consecutive frames and leg joint locations have coherent displacement in a direction relative to the target sensor, it may be determined that the object is walking, thus determining that the target object has an intention to request support in walking.

Operation 202: Perform compliance control on the support robot when tactile sensors detect that an external force is applied to the mechanical arm during or after movement of the mechanical arm to the target joint location.

For example, compliance control is a control mode of obtaining a control signal from a force sensor, and controlling a robot through the signal, so as to cause the robot to move in response to a change of the signal. Compliance is classified into two types of active compliance and passive compliance. Through some auxiliary compliance mechanisms, robots can naturally match external forces when making contact with an environment. The situation is referred to as passive compliance control. Robots actively control acting forces through some control policies through force feedback information. The situation is referred to as active compliance control.

In one embodiment, during or after movement of the mechanical arm to the target joint location, when the tactile sensors detect that the external force is applied to the mechanical arm, it may be determined that the target object is in contact with the support robot. Accordingly, compliance control is performed on the support robot, which may cause the support robot to respond appropriately according to a motion posture of the target object. For example, the support robot may be controlled to maintain a fixed output force without being affected by external pressure, or the support robot may be controlled to change a location and a velocity accordingly with the external force according to a preset impedance characteristic, so as to maintain gentle interaction with the target object, or to provide feedback to a touch or contact while satisfying a specific posture. Specifically, compliance control of the support robot may be implemented by adjusting parameters of whole-body joints (including upper limbs and lower limbs) of the support robot, and for example, adjusting a target joint location, a target movement location, a motion velocity and acceleration of each joint, and other parameters, so as to reduce impacts or excessive pressure on the target object during supporting and improve support comfort.

In one embodiment, compliance control may be performed on the mechanical arm of the support robot during supporting. Specifically, parameters such as torque, a location, a velocity, and acceleration of each joint of the mechanical arm may be adjusted to change a motion trajectory and location of the mechanical arm of the support robot. For example, in a case that the tactile sensors detect that the external force is applied to the mechanical arm, torque output of a corresponding joint may be adjusted in real time according to a location and direction of the applied external force, so as to maintain a posture of the target object or implement gentle interaction with the target object. Meanwhile, dynamic impedance parameters of the corresponding joint may be increased to make motion of the mechanical arm smoother and slower, so as to match the posture of the target object. In addition to performing compliance control on the mechanical arm, whole-body compliance control may be performed on the support robot. By adjusting whole-body joints of the support robot to match the posture of the target object, the support robot can better imitate limb motion characteristics of a human, thus improving comfort in a supporting process. For example, when the support robot is a wheeled robot provided with the mechanical arm, a degree of freedom of an omnidirectional wheel (such as a forward distance, a backward distance, and a rotation angle of the omnidirectional wheel) and movement acceleration of the omnidirectional wheel may be adjusted to cooperate with compliant motion of the mechanical arm in a case that the tactile sensors detect that the external force is applied to the mechanical arm. When the support robot is a legged robot provided with the mechanical arm, joint controllers between two feet and a waist may be adjusted to change a height from the waist to the feet so as to cooperate with compliant motion of the mechanical arm in a case that the tactile sensors detect that the external force is applied to the mechanical arm. The complaint motion of the mechanical arm means that when the mechanical arm is in contact with an external environment or object, the mechanical arm can adjust a movement track, a velocity, or a force in real time according to information such as a contact force or location, to adapt to changes of the external environment or object, thus achieving a smooth and precise interaction effect.

In one embodiment, the target sensors have a plurality of types, and may specifically include a visual sensor and a pose sensor. The pose sensor may detect a spatial location and direction of the target object, or may detect a spatial location and direction of the support robot. When the pose sensor detects that a location of the support robot relative to the target object changes, the target movement location of the support robot may be adjusted in real time, to achieve or maintain a desired relative pose. Thus, the target movement location may be determined according to relative locations between the target object and the pose sensor. The visual sensor may identify the target object and a posture of the target object. When relative postures, i.e., relative locations, between the target object and the visual sensor change, a motion location of the mechanical arm of the support robot may be adjusted in real time, to respond to a posture change of the target object. Thus, the target joint location is determined according to the relative locations between the target object and the visual sensor.

In one embodiment, at least one of the visual sensor and the pose sensor is provided. A measurement error of a single sensor can be mutually compensated by combining data of a plurality of sensors, thus improving accuracy and reliability of object perception. For example, the pose sensors may include an inertial measurement unit, a laser radar, an ultrasonic sensor, etc., such that the relative locations between the target object and the pose sensors may be comprehensively determined based on the relative locations between each pose sensor and the target object. Specifically, sensor data of each pose sensor at the same moment is collected, noise filtering is performed on all the sensor data, and fusion analysis is performed on all the sensor data through a pre-trained neural network model, such that the relative locations between the target object and the pose sensors are determined. Accordingly, the visual sensors may include a depth camera, a stereoscopic camera, an infrared camera, etc. A plurality of visual sensors may be combined to determine a three-dimensional posture of the target object more accurately, so as to determine the relative locations between the visual sensors and the target object.

In one embodiment, the support robot may be provided with a visual sensor, such as a camera, and a terminal may perceive and identify a person within a computer vision range through the visual sensor provided by the support robot, and identify the perceived posture of the target object. Image data of an environment where the support robot is currently located may be photographed in real time through the visual sensor, the image data is analyzed, and whether a subject of the target object exists in the image data is determined. Specifically, human body identification may be performed on the image data through a human body posture identification algorithm such as a Mediapipe identification frame, to determine a location of a human skeleton point, such that key point detection of the target object may be performed on the image data. After key points of the target object are determined, posture identification may be performed on the target object, to determine a human body posture of the target object, and further perform a support task by determining whether the target object has an intention to request support. Human body posture identification algorithms having different response rates and complexity may be selected based on a sampling frequency of the visual sensor. For example, a video stream frame rate of the visual sensor is 30 frames per second, such that a model with medium model complexity may be selected to identify a human body posture, and a frequency at which each video node identifies the human body posture is 28 Hz, thus implementing real-time human body identification on current image data of the visual sensor. When the target object is detected to have no intention to request support, the support robot may continue to perform a current support task, or continue to perform posture identification on the target object to determine whether the target object has the intention to request support.

For example, computer vision (CV) is a science that studies how to use a machine to “see”, and further is to use a camera and a computer instead of human eyes to implement machine vision, such as identification and measurement of a target, and further perform graphic processing, such that the computer processes the target into an image more suitable for observation of human eyes, or an image transmitted to an instrument for detection. In the embodiment of this application, processing such as key point detection of the target object on image data and posture identification of the target object is performed through the visual sensor, thus improving control efficiency of the support robot.

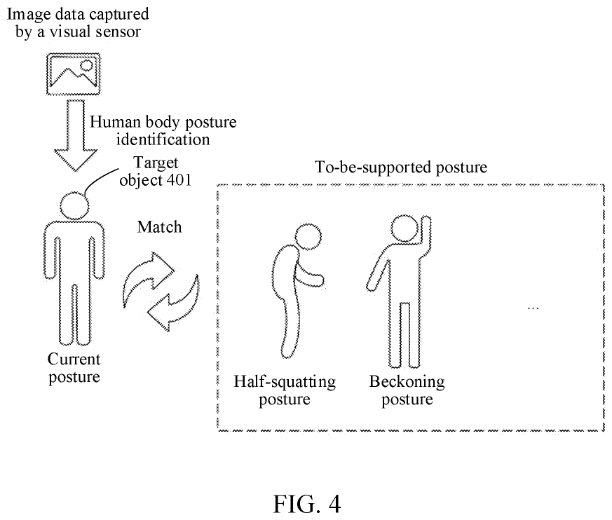

With reference to FIG. 4, FIG. 4 is a schematic diagram of detecting that a target object has an intention to request support according to an embodiment of this application. A pre-trained posture estimation network model may be deployed in a terminal. After image data captured by a visual sensor is obtained, feature extraction may be performed on the image data to obtain first image data. The first image data is input into the posture estimation network model to obtain human body key points. Then, a current posture of a target object 401 may be determined according to the human body key points, and the current posture of the target object is further matched with a to-be-supported posture with the intention to request support. If the current pose matches the to-be-supported posture, the terminal may determine that the target object has the intention to request support. As shown in FIG. 4, the to-be-supported posture may be a body posture such as half-squatting, squatting, walking, or a specific gesture made by a user. If a plurality of user objects exist in the image data, a posture of each user object may be identified, and the user object whose current posture matches the to-be-supported posture may be determined as the target object.

In addition, historical image data captured by the visual sensor at a previous moment may be obtained, and feature extraction may be performed on the historical image data at the previous moment, to obtain second image data. The first image data and the second image data may be concatenated to obtain third image data. The third image data is input into the posture estimation network model, to obtain target key points. An estimated posture of the target object is determined according to the target key points. A more accurate object posture can be obtained by combining motion changes in consecutive frames. If the estimated posture matches the to-be-supported posture with the intention to request support, the terminal may determine that the target object has the intention to request support.

In one embodiment, the support robot may further be provided with an acoustic sensor, such as a microphone. The terminal may perceive voice information transmitted by the target object through the acoustic sensor arranged on the support robot, perform voice identification on the voice information, and determine whether the voice information includes the intention to request support.

In some embodiments, before operation 201, processing is performed as follows: voice information of the target object is detected; feature extraction is performed on the voice information, to obtain voice features; classification is performed based on the voice features, to obtain a prediction type of the voice features; and it is determined that the target object has the intention to request support in response to the prediction type indicating that the target object has the intention to request support.

For example, the voice information of the target object may be detected through the acoustic sensor arranged on the support robot. The acoustic sensor converts a sound made by a user from a voice signal into an electrical signal, and then converts the electrical signal into an analog signal. The voice information is represented as the analog signal. The voice information may be processed through a neural network model in the following mode of converting an analog voice signal into a digital signal, and extracting features from a digitalized voice signal through sampling and quantization. Common feature extraction methods include a mel-frequency cepstral coefficient (MFCC), filter banks, a spectrum feature, etc. The neural network model may be a convolutional neural network or a recurrent neural network. A gating unit in the neural network model classifies and processes the voice features, to obtain the prediction type of the voice features. The prediction type includes a case that the target object has an intention to request support and a case that the target object has no intention to request support. When the prediction type indicates that the target object has the intention to request support, processing of operation 201 is performed, that is, the support robot is controlled to support the user.

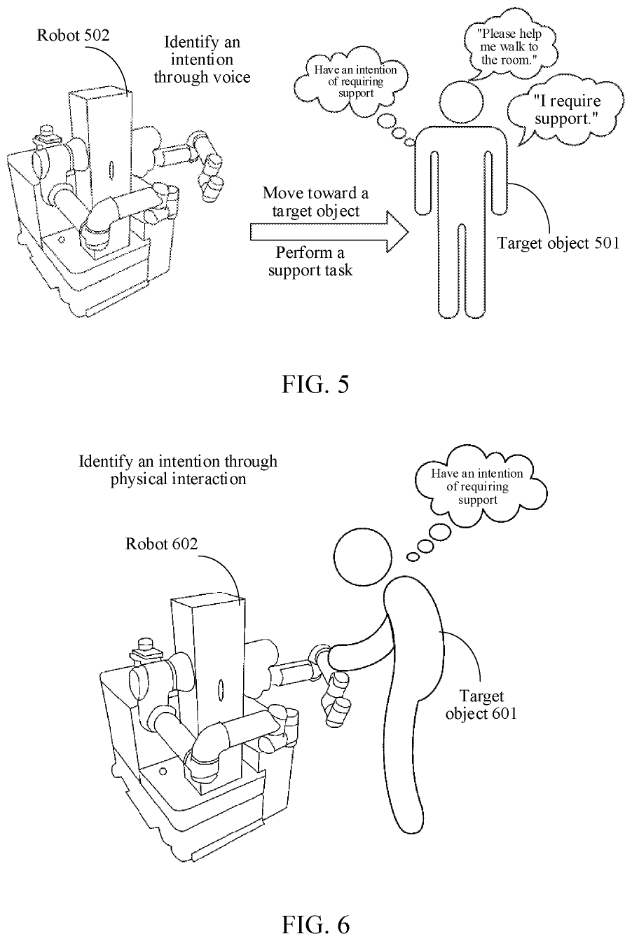

For example, with reference to FIG. 5, FIG. 5 is a schematic diagram of detecting that a target object has an intention to request support according to an embodiment of this application. When the user utters sentences with a semantic meaning of requiring support, such as “Please help me walk to the room” or “I require support”, it may be determined that the target object has the intention to request support, such that the support robot is controlled to perform a support task. For example, in FIG. 5, a support robot 502 identifies an intention of the user based on voice. When a target object 501 says “Please help me walk to the room”, in response to detecting that the target object 501 has the intention to request support, the support robot 502 performs the support task.

Artificial intelligence (AI) is a theory, a method, a technology, and an application system that use a digital computer or a machine controlled by a digital computer to simulate, extend, and expand human intelligence, perceive an environment, obtain knowledge, and use the knowledge to obtain an optimal result. In the embodiment of this application, the neural network model is used to detect the voice information of the user, and whether the user has the intention to request support is determined based on the voice information, such that control efficiency of the robot is improved.

In the embodiment of this application, whether the user has the intention to request support is detected through voice, such that convenience of controlling the robot can be improved, a response velocity of the robot can be enhanced, use is facilitated, and versatility of the robot in actual application scenes is improved.

In one embodiment, with reference to FIG. 6, FIG. 6 is a schematic diagram of detecting that a target object has an intention to request support according to an embodiment of this application. A hand of a target object 601 is placed on a mechanical arm of a robot 602. A terminal may perceive an interaction force applied from the outside through tactile sensors arranged on the mechanical arm of the support robot. As shown in FIG. 6, if the terminal detects that the external force is applied to the mechanical arm through the tactile sensors in a period when the support robot is not controlled to perform a support task, an object with a smallest relative distance to a target sensor may be regarded as the target object, and it may be determined that the target object has an intention to request support. Or, the terminal may invoke a visual sensor (if the support robot is provided with a visual sensor such as a camera) to perceive and identify a posture of each object within a computer vision range, regard an object satisfying a to-be-supported posture as a target object, and determine that the target object has an intention to request support.

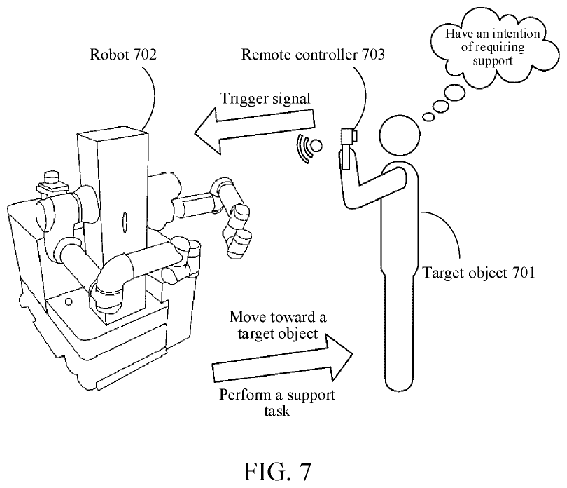

In one embodiment, with reference to FIG. 7, FIG. 7 is a schematic diagram of detecting that a target object has an intention to request support according to an embodiment of this application. The support robot may be provided with a help button or a remote controller arranged detachably on the support robot. If a terminal may perceive a signal generated when the help button or the remote controller is triggered, it may be determined that a target object triggering the help button or the remote controller has the intention to request support.

In some embodiments, before operation 201, processing is performed as follows: in response to receiving a first signal for the support robot, the first signal is detected, to obtain a detection result; and it is determined that the target object has the intention to request support in response to the detection result indicating that the first signal is transmitted by a pre-configured remote controller.

For example, the first signal is transmitted by the remote controller arranged detachably on the support robot. The first signal carries a device identifier of the remote controller. The terminal in the support robot parses the first signal, to obtain the device identifier of the remote controller. In response to presence of a device identifier of a pre-configured remote controller in the first signal, it is determined that the first signal is configured for indicating that the target object has the intention to request support, and operation 201 is performed.

For example, in FIG. 7, a target object 701 holds a remote controller 703, and the target object 701 transmits a signal by triggering the remote controller 703. A receiver in a robot 702 receives the signal, and the robot moves toward the target object 701 based on the signal. After moving to a target location, the robot 702 performs a task of supporting the target object 701.

Or, the terminal may invoke a visual sensor (if the support robot is provided with a visual sensor such as a camera) to perceive and identify a posture of each object within a computer vision range, regard an object satisfying a to-be-supported posture as a target object, and determine that the target object has an intention to request support.

In the embodiment of this application, state information of the robot may be controlled according to a requirement of a user through the remote controller, such that the robot can perform timely adjustment and responses, thus ensuring that the robot works as expected. The robot is controlled through a dedicated remote controller, such that difficulty for the user to operate the robot is reduced, and versatility of the robot is improved.

In one embodiment, sensor data related to an object is captured through a target sensor. For example, feature extraction and concatenation are performed on image data captured by a visual sensor and pose data detected by a pose sensor, to obtain multi-source sensor data. The multi-source sensor data is input into a pre-trained deep learning model, such as a convolutional neural network model, or a real-time object detection algorithm, such as a you only look once (YOLO) target detection algorithm, and a single shot multibox detector (SSD) object detection algorithm. In this way, human objects in the sensor data (for example, frame images) may be quickly detected and locations of the human objects may be estimated. A posture estimation model, such as an OpenPose human posture estimation algorithm model or an AlphaPose posture estimation algorithm based on human body key point detection, may be used to analyze postures of the human objects in the sensor data, analyze behavior patterns and motion intentions of the human objects, and determine whether the objects have an intention to request support. When the target object is detected to have an intention to request support, a dynamic path planning algorithm may be used to calculate an optimal path for the support robot to reach a target movement location, and the support robot may be controlled to move toward the to-be-supported target object. The target sensor may perceive not only the human objects but also non-human objects, namely obstacle objects. For example, a laser radar, a visual sensor, or another sensor perceives an environment around the support robot. In this way, obstacle avoidance may be implemented by using the target sensor to perceive an obstacle on a movement path during movement. Meanwhile, the target sensor is used to perceive the target object in real time during movement, a relative distance between the target object and the target sensor is corrected, and the target movement location for supporting the target object is adjusted. After the support robot reaches the target movement location, the mechanical arm may be controlled to move to a human body supporting point, i.e., the target joint location. Meanwhile, a triggering condition of tactile sensors on the mechanical arm and the relative distance between the target sensor and the target object are perceived to determine a state of the target object, and a location and a force of the mechanical arm are adjusted in real time to adapt to motion and a balance state of the target object.

Specifically, the support robot and the control method for a support robot according to the embodiment of this application may be applied to various man-machine interaction scenes such as a medical rehabilitation scene, a daily care scene, a public place assistance scene, and a rescue and disaster relief scene, with a wide range of application scenes. For example, in a hospital or rehabilitation center, the support robot may be controlled to assist a patient or the elderly in posture changes such as walking, standing up, and sitting down. As the support robot can perceive a state of a target object and adjust a support solution in real time according to the state and requirements of the target object, the support robot can assist the object in rehabilitation while improving support comfort, and can reduce a workload of a physical therapist. Further, for example, the support robot is controlled to detect an activity state of the elderly in real time, assist the elderly in various movements (such as going up and down stairs, standing up, and walking) indoors or outdoors, and provide timely assistance in emergency situations (such as lifting up after a fall). Further, for example, in public places such as stations or shopping malls, the support robot can help passengers or customers with limited mobility reach their destinations. Specifically, in a station scene, the support robot may assist a passenger with limited mobility in moving from a waiting station to a side of a bus door, and support the passenger to board a bus door step zone, or support the passenger to sit down inside a bus. In a shopping mall scene, the support robot may support a customer to step onto steps of an escalator.

In one embodiment, in a process of controlling the support robot to move toward the target object, current target pose data of the pose sensor may be obtained, and the target pose data may be transformed based on a preset first transformation matrix, to obtain the target movement location; and the support robot may be controlled to move toward the target object based on the target movement location.

In one embodiment, the pose sensor may detect human body pose data of the target object. That is, the target pose data may be human body pose data obtained by measuring the target object through the pose sensor at a current moment, or may be obtained through calculation based on the measured human body pose data. The preset first transformation matrix may refer to a pose transformation matrix for converting human body space coordinates to space coordinates of the support robot, and is configured for representing a pose transformation relationship between the target movement location of the support robot and a location of the target object. Thus, an expected location, i.e., the target movement location, of the support robot relative to the target object is obtained by converting space coordinates where the target object is located. Further, the support robot is controlled to move to the target movement location near the target object, so as to perform the support task on the target object.

In one embodiment, a plurality of first candidate transformation matrices may be preset to adapt to different postures of the target object or different support requirements. For example, different transformation matrices may be selected according to a motion mode and a posture of the target object, to determine a corresponding target movement location of the support robot, thus ensuring support safety and comfort. After the target movement location is determined, in a process of controlling the support robot to move toward the target object based on the target movement location, pose data of the target object may be detected in real time, and the target movement location of the support robot may be updated in real time based on the first transformation matrix. Or pose data of the target object may be detected in real time, a motion mode and a posture of the target object may be determined, and the first transformation matrix may be updated in real time to adjust the target movement location of the support robot.

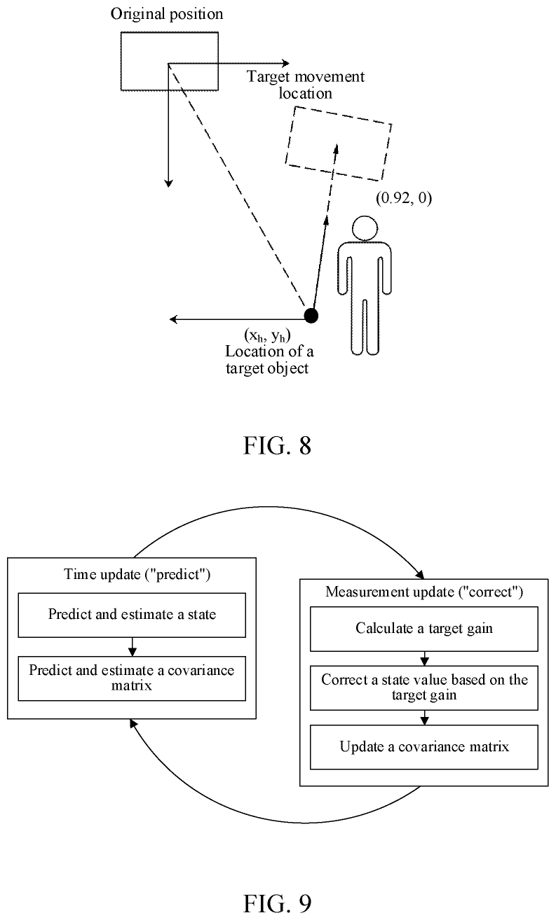

With reference to FIG. 8, FIG. 8 is a schematic diagram of a location transformation relationship according to an embodiment of this application. Target pose data of a target object at a current moment may be detected through a pose sensor. State data, namely a location and a direction, of the target object, may be extracted from the target pose data, and for example, location coordinates (xₕ,yₕ,1) of the target object relative to the support robot, and an angle θₕ of the target object relative to the support robot. Assuming that a support requirement of the target object is walking support, the first transformation matrix corresponding to walking support may be determined from a plurality of first candidate transformation matrices. Thus, based on the preset first transformation matrix [0.92,0,1]^{T}, a location of the target object is transformed to obtain a target movement location of the support robot. Thus, the support robot may be controlled to move from an original location toward the target object and move to the target movement location, so as to perform a task of supporting the target object. Specifically, a calculation process of the target movement location (x_{base},y_{base},1) is shown in the following formula:

$$[ \begin{matrix}{x}_{base} \\ {y}_{base} \\ 1\end{matrix} ] = [ \begin{matrix}cos {θ}_{h} & sin {θ}_{h} & {x}_{h} \\ - sin {θ}_{h} & cos {θ}_{h} & {y}_{h} \\ 0 & 0 & 1\end{matrix} ] [ \begin{matrix}0.92 \\ 0 \\ 1\end{matrix} ] = [ \begin{matrix}0.92 cos {θ}_{h} + {x}_{h} \\ - 0.92 sin {θ}_{h} + {y}_{h} \\ 1\end{matrix} ] \qquad ( 1 )$$

Thus, the target movement location of the support robot is related to a location of the target object relative to the support robot. As the support robot continuously moves, the target pose data detected by the pose sensor continuously changes, and the determined target movement location changes accordingly. That is, the target movement location of the support robot changes with relative locations between the target object and the pose sensor. The target movement location may be determined based on a space coordinate system of the support robot. Thus, although the target movement location continuously changes, the target movement location at each moment may be fixed relative to a world coordinate system or a coordinate system where the target object is located.

In one embodiment, the target pose data may be synthesized from pose data measured by the pose sensor at a plurality of moments. Specifically, first pose data obtained by predicting the pose sensor at a previous moment and a first covariance matrix may be obtained, current second pose data may be predicted based on the first pose data, and a current second covariance matrix may be predicted based on the first covariance matrix; actual pose data currently collected by the pose sensor may be obtained, and a target gain may be determined based on the actual pose data and the second covariance matrix; and the second pose data may be corrected based on the target gain, to obtain the current target pose data of the pose sensor.

In one embodiment, due to a measurement error of the pose sensor, it is easy to confuse the target object (for example, a person) with a non-target object (for example, an obstacle), causing a support task to fail to be performed. Thus, it is necessary to correct human body pose data directly measured by the pose sensor, so as to obtain the target pose data with high accuracy. With reference to FIG. 9, FIG. 9 is a schematic flowchart of performing data processing on pose data measured by a pose sensor according to an embodiment of this application. As shown in FIG. 9, for correction of pose data, firstly, pose data at a previous moment is used for prediction, which includes performing state prediction estimation on the pose data and performing prediction estimation on a covariance matrix corresponding to a predicted state quantity. A predicted state value is corrected based on a measured value at a current moment, which includes calculating a target gain, then correcting the predicted state value based on the target gain, and finally updating a previously predicted and estimated covariance matrix. Human body pose data may include angles and directions of human body joints, three-dimensional coordinate locations of key body points, etc. Specifically, the human body pose data detected by the pose sensor may be understood as a movement state of the target object, including a location and a velocity of the target object, i.e., x=[pₓ, p_{y}, θ, \dot{p}ₓ, \dot{p}_{y}, \dot{θ}]. First pose data refers to pose data obtained by predicting the pose data measured by the pose sensor at the previous moment. As the movement state of the target object is not affected by external control input, an external control vector and an external control input matrix may be ignored for a state equation of a correction system. Thus, second pose data predicted at a current moment may be obtained by calculating a product of the first pose data predicted at the previous moment and a state transition matrix, that is, a state of the target object at the current moment may be predicted. The state transition matrix is configured for describing a relationship of the correction system changing from the previous moment to the current moment. Specifically, the state transition matrix is as follows:

$$A = [ \begin{matrix}1 & 0 & 0 & Δ T & 0 & 0 \\ 0 & 1 & 0 & 0 & Δ T & 0 \\ 0 & 0 & 1 & 0 & 0 & Δ T \\ 0 & 0 & 0 & 1 & 0 & 0 \\ 0 & 0 & 0 & 0 & 1 & 0 \\ 0 & 0 & 0 & 0 & 0 & 1\end{matrix} ]$$

ΔT denotes a time interval of the correction system, represents a time difference between the previous moment and the current moment, and is configured for correcting a change of a state variable caused by the time interval.

According to the state equation of the correction system ignoring influence of the external control input, a calculation formula of the second pose data may be obtained, which may be specifically shown in the following formula:

$${x}_{k}^{-} = {Ax}_{k - 1} + {ω}_{k} \qquad ( 2 )$$

$${x}_{k}^{-}$$

denotes the second pose data predicted at the current moment, xₖ₋₁ denotes the first pose data predicted at the previous moment, and ωₖ denotes process noise satisfying Gaussian distribution in the correction system.

In one embodiment, a first covariance matrix is a matrix that measures, when first pose data is obtained by predicting the pose sensor at the previous moment, an uncertainty degree of the predicted first pose data, and is configured for representing an uncertainty degree of state estimation at the previous moment in the correction system. The first covariance matrix is an expression of error distribution of the first pose data. Diagonal elements in the first covariance matrix represent variances of all state variables (i.e., elements of the first pose data) of the first pose data, and off-diagonal elements represent covariances between different state variables, and are configured for reflecting correlation between different state variables. Based on the correction system, a second covariance matrix corresponding to the second pose data at the current moment may be obtained by performing multiplication of the state transition matrix and the first covariance matrix. Specifically, a calculation formula of the second covariance matrix may be shown in the following formula:

$${P}_{k}^{-} = {AP}_{k - 1} {A}^{T} + Q \qquad ( 3 )$$

$${P}_{k}^{-}$$

denotes a second covariance matrix corresponding to second pose data

$${x}_{k}^{-} ,$$

Pₖ₋₁ denotes a first covariance matrix corresponding to first pose data xₖ₋₁, and Q denotes a noise covariance matrix corresponding to process noise ωₖ of the correction system.

In one embodiment, the target gain is configure for optimizing prediction accuracy by combining a predicted state (i.e., the second pose data) of the pose sensor and an observed quantity (i.e., the actual pose data) measured by the pose sensor. Thus, the second pose data and the actual pose data are judged and weighed, the second pose data is corrected, and target pose data is obtained. Specifically, a feedback gain matrix is calculated through the second covariance matrix and a preset observation matrix in the correction system. Further, the target gain is calculated through the actual pose data and the feedback gain matrix. A calculation formula of the feedback gain matrix may be shown in the following formula:

$${K}_{k} = {P}_{k}^{-} {{H}^{T} ( {HP}_{k}^{-} {H}^{T} + R )}^{- 1} \qquad ( 4 )$$

Kₖ denotes the feedback gain matrix, H denotes the observation matrix, and R denotes a measurement noise matrix. Specifically, the observation matrix may be expressed as:

$$H = [ \begin{matrix}1 & 0 & 0 & 0 & 0 & 0 \\ 0 & 1 & 0 & 0 & 0 & 0 \\ 0 & 0 & 1 & 0 & 0 & 0\end{matrix} ]$$

After the feedback gain matrix is obtained, the actual pose data and the second pose data may be judged and weighed through the feedback gain matrix, to obtain the target gain. A specific calculation formula may be shown in the following formula:

$$B = {K}_{k} ( {z}_{k} - {Hx}_{k}^{-} ) \qquad ( 5 )$$

B denotes the target gain, and zₖ denotes the actual pose data. The actual pose data may be obtained through low-pass correction based on initial pose data directly measured by the pose sensor. Specifically, a correction calculation formula of the actual pose data may be shown in the following formula:

$${z}_{k} = α {z}_{k}^{-} + ( 1 - α ) {z}_{k - 1} \qquad ( 6 )$$

α denotes a correction coefficient, and the correction coefficient is a low-pass correction intensity.

$${z}_{k}^{-}$$

denotes second initial pose data directly measured by the pose sensor at the current moment. zₖ₋₁ denotes historical actual pose data obtained through low-pass correction of first initial pose data

$${z}_{k - 1}^{-}$$

directly measured by the pose sensor at the previous moment.

The second pose data is corrected based on the target gain, such that current target pose data of the pose sensor may be obtained. A specific correction formula of the target pose data xₖ may be shown in the following formula:

$${x}_{k} = {x}_{k}^{-} + B \qquad ( 7 )$$

After the second pose data in a predicted state is corrected through the target gain, the second covariance matrix corresponding to the second pose data may be updated. A specific matrix update formula may be shown in the following formula:

$${P}_{k} = ( 1 - {K}_{k} H ) {P}_{k}^{-} \qquad ( 8 )$$

Pₖ denotes the updated second covariance matrix. The predicted second covariance matrix

$${P}_{k}^{-}$$

is updated through the feedback gain matrix Kₖ and the observation matrix H of the correction system, such that the updated second covariance matrix Pₖ may be used to predict target pose data at a next moment.

In one embodiment, a relationship between the predicted state and the observed quantity in the correction system may be represented by an observation equation. Specifically, the observation equation may be shown in the following formula:

zₖ=Hxₖ+vₖ (9)

vₖ denotes observation noise satisfying Gaussian distribution in the correction system.

In one embodiment, in a process of controlling the mechanical arm to move to a target joint location, current image data of the visual sensor may be obtained, and key point locations of a plurality of key points of the target object in the image data may be determined; a coordinate system where the key point locations are located may be converted to a coordinate system where the support robot is located, and a center location of the plurality of key points may be determined based on the plurality of converted key point locations; and the center location may be transformed based on a preset second transformation matrix, to obtain the target joint location, and motion of the mechanical arm may be controlled based on the target joint location.

In one embodiment, the target object may have the plurality of key points. Specifically, the key points of the target object may include prominent feature points on a human body, such as eyes, ears, shoulders, a waist, elbow joints, wrists, hip joints, knee joints, ankles, and other joint points. When key point detection is performed on the image data, the key points may be determined from the plurality of joint points based on a main part of the target object displayed in the image data. For example, if a main part of the target object displayed in the image data is an upper limb part of the target object, joint points such as shoulders and a waist may be selected as key points. If a main part of the target object displayed in the image data is a lower limb part of the target object, joint points such as hip joints and knee joints may be selected as key points. Or, when key point detection is performed on the image data, the key points may be determined from the plurality of joint points based on a support requirement of the target object. For example, if a support requirement of the target object is supporting the target object to stand up, joint points such as shoulders, elbow joints, and wrists may be selected as key points. If a support requirement of the target object is supporting the target object to walk, joint points such as a waist, hip joints, and elbow joints may be selected as key points.

In one embodiment, the key points of the target object may be fixed joint points on a human body. When a plurality of fixed joint points of the target object cannot be detected from the image data, a target movement location is re-determined based on relative locations between the pose sensor and the target object, and then image data of the visual sensor is re-obtained for analysis after the support robot is re-controlled to reach a new target movement location. For example, the key points of the target object may be four key points on the human body, namely a left shoulder, a right shoulder, a left hip, and a right hip. When the four key points of the target object cannot be completely detected from the image data captured by the visual sensor, it may be determined that the support robot is currently unable to accurately perceive the target object, which may easily lead to perception errors. Meanwhile, it may be determined that the relative locations between the support robot and the target object, for example, with a distance being too small or too great, make it difficult to ensure safe performing of the support task. Thus, the target movement location may be re-determined based on the relative locations between the pose sensor and the target object, and the support robot may be controlled to move to the updated target movement location. Then, the visual sensor is used to capture current image data until the four key points including the left shoulder, the right shoulder, the left hip, and the right hip of the target object may be completely detected in the new image data.

In one embodiment, the key point locations may refer to coordinate points of all the key points in the image data in a pixel coordinate system. The pixel coordinate system may use an upper-left corner of an image as an origin, a horizontally rightward direction as a positive direction of an abscissa axis, and a vertically downward direction as a positive direction of an ordinate axis. After the plurality of key points in the image data are identified through image identification, the key point locations, i.e., two-dimensional coordinate points in the pixel coordinate system, of all the key points in the image data may be determined through image registration. The coordinate system where the key point locations are located, i.e., the pixel coordinate system, is converted to the coordinate system where the support robot is located. In this case, the converted key point locations are represented as three-dimensional coordinate points of all the key points in the coordinate system where the support robot is located. An arithmetic mean of the plurality of converted key point locations is calculated to obtain the center location of the plurality of key points, i.e., coordinates of a center of the plurality of key points. The center location is transformed through the preset second transformation matrix, to obtain the target joint location. The second transformation matrix may refer to a transformation matrix for converting the center location to a to-be-supported location of the mechanical arm. That is, the center location serves as a reference point for the to-be-supported location of the support robot, to determine the target joint location of the mechanical arm.

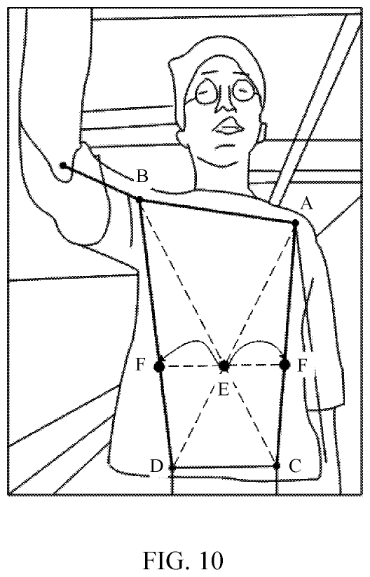

In one embodiment, with reference to FIG. 10, FIG. 10 is a schematic diagram of a center location according to an embodiment of this application. Image data of a current environment where a support robot is located is captured through a visual sensor. As shown in FIG. 10, due to a limited photographing angle of the visual sensor, if the image data captured by the visual sensor needs to include a main body of a target object, a relative distance between the visual sensor and the target object needs to be greater than a minimum photographing distance of the visual sensor. For example, if the visual sensor is a depth camera and a minimum photographing distance of the depth camera is 50 cm, the main body of the target object may be displayed in the image data captured by the visual sensor in a case that a relative distance between the depth camera and the target object reaches 50 cm. Otherwise, it is necessary to adjust relative locations between the support robot and the target object and re-capture the image data. If the main body of the target object is displayed in the image data, key point detection of the target object may be performed on the image data. Relative locations between the target object and the visual sensor may be determined through four key points of a human body, namely a left shoulder (marked as point A in FIG. 10), a right shoulder (marked as point B in FIG. 10), a left hip (marked as point C in FIG. 10), and a right hip (marked as point D in FIG. 10), and meanwhile, a distance between the target object and the visual sensor may be determined. A center location (marked as point E in FIG. 10) of the four key points of the left shoulder, the right shoulder, the left hip, and the right hip is calculated. In this case, for the target object shown in FIG. 10, the center location is located at a waist of the target object. Thus, the waist of the target object may regarded as a reference point for a to-be-supported location of the mechanical arm of the support robot, i.e., a reference point for the target joint location. By transforming the center location through the second transformation matrix, support locations on two sides of the waist may be obtained as the target joint locations (marked as point F in FIG. 10).

In one embodiment, parameter calibration may be performed on the visual sensor, to obtain an intrinsic matrix of the visual sensor; a mounting location of the visual sensor in the support robot may be determined, and an extrinsic matrix of the visual sensor may be determined according to the mounting location; and the coordinate system where the key point locations are located may be converted to the coordinate system where the support robot is located based on the intrinsic matrix and the extrinsic matrix.

In one embodiment, the intrinsic matrix of the visual sensor describes internal optical characteristics of the visual sensor, including a focal length and an imaging center (optical center). The focal length of the visual sensor may be represented by an x-axis focal length and a y-axis focal length, with a unit of pixels. The optical center may be represented by a projection location on an image plane. For example, after parameter calibration of the visual sensor, the intrinsic matrix of the visual sensor may be obtained. The intrinsic matrix may be expressed as follows:

$$[ \begin{matrix}{f}_{x} & 0 & {c}_{x} \\ 0 & {f}_{y} & {c}_{y} \\ 0 & 0 & 1\end{matrix} ] = [ \begin{matrix}644.59 & 0 & 633.42 \\ 0 & 644.14 & 372.04 \\ 0 & 0 & 1\end{matrix} ]$$

ƒₓ denotes the x-axis focal length, ƒ_{y} denotes a y-axis focal length, and (cₓ, c_{y}) denotes a location of the optical center.

In one embodiment, the extrinsic matrix of the visual sensor defines a spatial relationship between a coordinate system of the visual sensor and a coordinate system where the support robot (base) is located. The extrinsic matrix includes a rotation matrix and a translation matrix. The rotation matrix is generally a 3×3 matrix, representing rotation of the visual sensor in the coordinate system of the support robot (base). The translation matrix is generally a 3×1 vector, and configured for representing a location of the visual sensor relative to the support robot (base). For example, the extrinsic matrix may be obtained according to the mounting location of the visual sensor in the support robot, and may be specifically expressed as follows:

$$[ \begin{matrix}R & T \\ 0 & 1\end{matrix} ] = [ \begin{matrix}0 & 0 & 1 & 0.5459 \\ 0 & - 1 & 0 & 0 \\ 1 & 0 & 0 & 1.1241 \\ 0 & 0 & 0 & 1\end{matrix} ]$$

R denotes the rotation matrix, and T denotes the translation matrix.

In one embodiment, to convert the coordinate system where the key point locations are located to the coordinate system where the support robot is located, the coordinate system where the key point locations are located, i.e., a pixel coordinate system, may be converted to the coordinate system where the visual sensor is located, and then the coordinate system where the visual sensor is located may be converted to the coordinate system where the support robot (base) is located. A specific calculation process may be shown in the following formula:

$${Z}_{c} [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}R & T \\ 0 & 1\end{matrix} ] [ \begin{matrix}{X}_{B} \\ {Y}_{B} \\ {Z}_{B} \\ 1\end{matrix} ] \qquad ( 10 )$$

(u,v) denotes the pixel coordinate system, i.e., the coordinate system where the key point locations are located. (X_{c},Y_{c},Z_{c}) denotes the coordinate system where the visual sensor is located, and an origin of the coordinate system where the visual sensor is located is the optical center of the visual sensor. A Z axis is parallel to an optical axis of the visual sensor. Z_{c} denotes a photographing direction of the visual sensor. (X_{B},Y_{B},Z_{B}) denotes the coordinate system where the support robot (base) is located.

In one embodiment, kinematic modeling is performed on the support robot based on joint variables (for example, displacement, a velocity, acceleration, and a location) of the support robot, to obtain a kinetic model of the support robot, the kinetic model being configured for describing a relationship between joint torque of the support robot and joint acceleration of the support robot. For example, the kinetic model is a mathematical model configured for describing movement laws and kinetic behaviors of a robot subjected to an external force. The kinetic model is generally based on principles of classical mechanics, such as Newton-Euler equations and Lagrangian equations. Establishment of the kinetic model of the robot can be used to understand and predict movement responses of the robot, design controllers, and perform simulation analyses.

External force data is obtained through the tactile sensors arranged on the mechanical arm of the support robot. External force information of a force application point is converted to a coordinate system of a corresponding joint of the support robot through a transformation matrix, resulting in torque that the joint of the support robot needs to generate to match the external force information, i.e., the target joint torque. In this way, the support robot can generate a sufficient force to counteract the external force while maintaining movement compliance and supporting stability. Target joint acceleration of the support robot is determined according to the obtained target joint torque and the established kinetic model, and further compliance control is performed on the support robot based on the target joint acceleration.

In one embodiment, a mass coefficient may be determined according to a mass of the support robot, a joint location of the support robot, and a joint velocity of the support robot; then, a friction coefficient may be determined according to friction of the support robot during motion and the joint location of the support robot; a gravity coefficient may be determined according to gravitational acceleration of the support robot and the joint location of the support robot; and a first product of the mass coefficient and the joint acceleration of the support robot may be determined, and kinematic modeling may be performed on the support robot according to a sum of the first product, the friction coefficient, and the gravity coefficient, to obtain the kinetic model of the support robot.

In one embodiment, the mass coefficient may indicate inertial properties of each joint of the support robot. The mass coefficient may be understood as a mass matrix in the kinetic model of the robot, and is configured for describing mass distribution of each joint of the support robot. Specifically, the mass coefficient of each joint in the support robot may be determined based on the mass, the joint location, and the joint velocity of the corresponding joint of the support robot. The joint location of the support robot may be determined through a location encoder of each joint, and the mass coefficient may change with change of the joint location. The friction coefficient may be understood as a friction matrix in the kinetic model, and represents influence of friction on each joint of the support robot during motion. Joints at different joint locations correspond to different friction directions and magnitudes. Thus, the joints at different joint locations correspond to different friction coefficients. The gravity coefficient may be understood as a gravity matrix in the kinetic model, and configured for representing influence of gravity on each joint of the support robot. Joints at different joint locations are subjected to gravity in different directions, which affects posture transformation of each joint. The first product is obtained by multiplying the mass coefficient by the joint acceleration of the corresponding joint, and may represent an inertial force caused by the joint acceleration, i.e., an inertial force that each joint needs to counteract during motion. This ensures a timely response generated when the joint is subjected to the external force. Kinematic modeling is performed on the support robot through the sum of the first product, the friction coefficient, and the gravity coefficient. A specific formula of the obtained kinetic model may be shown in the following formula:

M(q)\ddot{q}+C(q,\dot{q})+g(q)=τ (11)

M(q) denotes a mass coefficient of a joint at a joint location q, M(q)\ddot{q} denotes a first product, \ddot{q} denotes a joint velocity of a joint at the joint location, C(q, \dot{q}) denotes a friction coefficient of a joint at the joint location, \dot{q} denotes a joint velocity of a joint at the joint location, g(q) denotes a gravity coefficient of the joint at the joint location q, and τ denotes joint torque of the joint at the joint location q.

Based on the kinetic model, the target joint acceleration generated under the action of the external force may be derived. A specific calculation formula of the target joint acceleration may be shown in the following formula:

\ddot{q}=M(q)⁻¹[τ−C(q,\dot{q})−g(q)] (12)

After the target joint acceleration is obtained, an adaptive control policy may be generated through a proportional-integral-derivative (PID) controller. This policy adjusts torque output of the corresponding joint to respond to the external force, thus controlling movement of the support robot based on the target joint acceleration.

In one embodiment, the tactile sensors each include a plurality of tactile units. Thus, a third transformation matrix configured for converting the coordinate system where the support robot is located to a coordinate system where a joint of the support robot is located may be determined, and a fourth transformation matrix configured for converting the coordinate system where the joint of the support robot is located to coordinate systems where the tactile units are located may be determined; then, a conversion function between the coordinate system where each of the tactile units is located and the coordinate system where the support robot is located may be determined according to the third transformation matrix and the fourth transformation matrix, and a derivative of the conversion function with respect to the joint location of the support robot may be determined, to obtain a Jacobian matrix corresponding to each of the tactile units; and a second product of the external force data collected by each of the tactile units and the corresponding Jacobian matrix may be determined, and target joint torque may be obtained based on a sum of the plurality of second products.

For example, the Jacobian matrix is a square matrix composed of a set of partial derivatives, and describes a rate of change of each component of a vector-valued function relative to each component of another vector-valued function. In the embodiment of this application, the Jacobian matrix is configured for describing a relationship between the joint velocity of the mechanical arm and a velocity of an end actuator. The Jacobian matrix maps a joint angular velocity or angular acceleration to a linear velocity or linear acceleration of the end actuator, which is a key part in movement planning.

In one embodiment, assuming that the support robot needs to perform a support task, a task space and a joint space of the support task have a nonlinear relationship. Specifically, coordinate points of the target joint location required to perform the support task are located in the coordinate system where the support robot is located, and coordinate points of external force data received during the support task are located in the coordinate system where the tactile unit is located. The external force data cannot be directly used to adjust the target joint location for compliance control. Thus, it is necessary to derive the conversion function determined by the third transformation matrix and the fourth transformation matrix. The conversion function may describe how to convert the coordinate system where each tactile unit is located to the coordinate system where the support robot is located. By performing differential operation on the joint locations of the support robot through the conversion function, the two different coordinate systems may be correlated, and the Jacobian matrix of the corresponding joint may be obtained. The Jacobian matrix of the corresponding joint may be shown in the following formula:

$$J ( q ) = \frac{σ f}{σ q} \qquad ( 13 )$$

ƒ denotes the conversion function, and J(q) denotes the jacobian matrix of the joint at the joint location q. The jacobian matrix of the corresponding joint may be obtained by calculating a partial derivative for the joint location q through the conversion function ƒ.

A derivative of the conversion function with respect to the joint location of the support robot is used as the Jacobian matrix of each tactile unit, and represents influence of a magnitude and a direction of the external force applied to each tactile unit on different joint locations. Specifically, assuming that a direction of a rotation axis of each joint i is represented by a unit vector ^{z}rᵢ and a location of an origin of a coordinate system of each joint may be represented by a vector pᵢ, the jacobian matrix Jᵢ(q) of the joint i may be expressed as follows:

$${J}_{i} ( q ) = [ \begin{matrix}\frac{σ {p}_{i}}{σ {x}_{b}} & \frac{σ {p}_{i}}{σ {y}_{b}} & … & \frac{σ {p}_{i}}{σ {q}_{k}} \\ {}_{}^{z} {r}_{{x}_{b}}^{} & {}_{}^{z} {r}_{{y}_{b}}^{} & … & {}_{}^{z} {r}_{i}^{}\end{matrix} ]$$

(x_{b},y_{b}) denotes the coordinate system where the support robot is located, qₖ denotes a k-th joint, 1<k<n, and n denotes a total quantity of all joints of the support robot, i.e., a sum of a quantity of joints of the mechanical arm and a quantity of joints of a base.

Since all the joints of the support robot rotate around a z axis, a pose transformation matrix Tᵢ of each joint i may be as follows:

$${T}_{i} = [ \begin{matrix}{}_{}^{x} {r}_{i}^{} & {}_{}^{y} {r}_{i}^{} & {}_{}^{z} {r}_{i}^{} & {p}_{i} \\ 0 & 0 & 0 & 1\end{matrix} ]$$

The Jacobian matrix corresponding to each tactile unit may be obtained by substituting the pose transformation matrix of the joint corresponding to each tactile unit into the Jacobian matrix of the corresponding joint. The external force data collected by each tactile unit is multiplied by the corresponding Jacobian matrix to obtain the second product. The Jacobian matrix of each tactile unit is used to convert the external force data received by the corresponding tactile unit to whole-body joints. That is, the second product may represent a force transmitted from each tactile unit to the whole-body joints. Further, the sum of all second products may represent a force exerted by an external part (i.e., the target object) during interaction with the mechanical arm in a supporting process, such that the target joint torque may be obtained through mapping. A calculation formula of the target joint torque t may be shown in the following formula:

$$τ = {\sum }_{i = 1}^{{σ}_{i}} {\sum }_{j = 1}^{{β}_{i}} {J}_{{σ}_{ij}} {F}_{{σ}_{ij}} \qquad ( 14 )$$

J_{σ}_{ᵢⱼ} denotes the jacobian matrix of a tactile unit j of a joint i of the mechanical arm, and F_{σ}_{ᵢⱼ} denotes external force data of a tactile unit j of a joint i of the mechanical arm. Specifically, since the external force ƒ_{z} is applied in a direction of the z axis, the external force data F_{σ}_{ᵢⱼ} may be expressed as follows:

F_{σ}_{ᵢⱼ}=[0,0,ƒ_{z}] (15)

In one embodiment, the joints of the support robot include a plurality of sub-arms and joint parts of the mechanical arms, and a base joint of the support robot. Thus, compliance control may be performed by separately adjusting joint torque and joint acceleration of each sub-arm and joint part of the mechanical arms. When the support robot is a wheeled robot, a base joint of the support robot may include an omnidirectional wheel mounted on a base. Joint torque of the omnidirectional wheel may be represented by a rotation angle of the omnidirectional wheel, and joint acceleration of the omnidirectional wheel may be represented by parameters such as an angular velocity and angular acceleration of the omnidirectional wheel, and torque generated by an electric motor to drive rotation of the omnidirectional wheel. Thus, compliance control may be implemented by adjusting a rotation direction, a rotation velocity, rotation acceleration, etc., of the omnidirectional wheel to adapt to a movement trend of a supported object. When the support robot is a legged robot, base joints of the support robot may include ankle joints, knee joints, hip joints, etc. Similarly, compliance control may be implemented by separately controlling joint torque and joint acceleration of the ankle joints, knee joints, and hip joints.

In one embodiment, to determine the fourth transformation matrix configured for converting the coordinate system where the joint of the support robot is located to the coordinate system where the tactile unit is located, it is necessary to perform kinematic modeling on each tactile unit of the tactile sensors based on a location on the mechanical arm, and establish a relationship between the tactile units and a kinematic chain on the mechanical arm. Each joint of the mechanical arm may be approximately regarded as a cylinder. Thus, it may be determined that the plurality of tactile units of the tactile sensor are distributed in a cylindrical shape on the surface of the mechanical arm, and the first distance between any two adjacent tactile units is equal. The first distance refers to a distance between two adjacent tactile units in a length direction of a connecting rod of the mechanical arm. Meanwhile, a posture of the coordinate system where the tactile unit is located relative to the coordinate system where the support robot is located is the same as that of a coordinate system where the joint corresponding to the tactile unit is located relative to the coordinate system where the support robot is located, such that a distance between each tactile unit and a starting end of the joint may be determined based on the first distance corresponding to the tactile unit, and further the fourth transformation matrix configured for converting the coordinate system where the joint of the support robot is located to the coordinate system where the tactile unit is located may be determined.

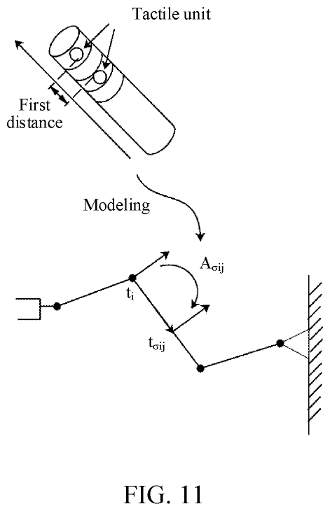

With reference to FIG. 11, FIG. 11 is a schematic diagram of converting a coordinate system where a joint of a support robot is located to a coordinate system where a tactile unit is located according to an embodiment of this application. Assuming that a first distance is 0.015 m, as shown in FIG. 11, the mechanical arm may be regarded as a cylinder, the first distance between any two adjacent tactile units is equal, that is, the plurality of tactile units distributed in a cylindrical shape on a surface of the mechanical arm may be divided into a plurality of rings along a height of the cylinder, a distance between two adjacent rings is fixed at 0.015 m, and the tactile units on the same ring may be modeled as the same unit. Thus, based on the first distance of the tactile units and locations of the tactile units (the rings where the tactile units are located) on the mechanical arm (cylinder), a conversion relationship between the tactile units and joints where the tactile units are located may be obtained. Further, a fourth transformation matrix may be obtained. The fourth transformation matrix may be specifically expressed as follows:

$${A}_{{σ}_{ij}} = [ \begin{matrix}1 & 0 & 0 & 0.015 \times j \\ 0 & 1 & 0 & 0 \\ 0 & 0 & 1 & 0 \\ 0 & 0 & 0 & 1\end{matrix} ]$$

As shown in FIG. 11, tᵢ may be understood as a coordinate system origin of a joint i where a tactile unit is located, and t_{σ}_{ᵢⱼ} may be expressed as a coordinate system origin of a tactile unit j in a joint i. (0.015×j) may be expressed as a distance between the coordinate system origin of the tactile unit j and the coordinate system origin of the joint i. A_{σ}_{ᵢⱼ} may be expressed as the fourth transformation matrix configured for converting a coordinate system where a joint of the support robot is located to a coordinate system where a tactile unit is located.

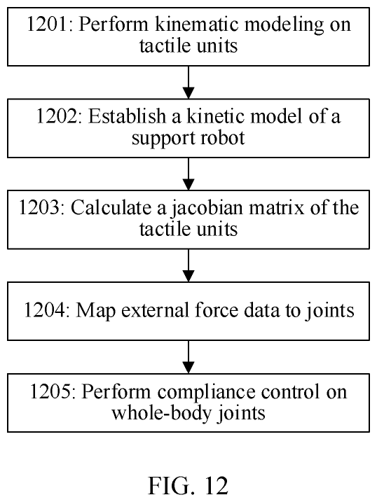

In one embodiment, with reference to FIG. 12, FIG. 12 is a schematic flowchart of compliance control according to an embodiment of this application. Whole-body compliance control may be implemented based on tactile sensors through the following operations.

Operation 1201: Perform kinematic modeling on tactile units.

For example, kinematic modeling is performed on each tactile unit of tactile sensors with respect to a location on a mechanical arm.

Operation 1202: Establish a kinetic model of the support robot.

Kinematic modeling is performed on the support robot to construct the kinetic model.

Operation 1203: Calculate a Jacobian matrix of the tactile units.

Based on modeling of the tactile units and the kinetic model of the support robot, the Jacobian matrix may be calculated for each tactile unit.

Operation 1204: Map external force data to joints.

The external force data received by the tactile sensors may be converted and mapped, through the Jacobian matrix, to force conditions of each joint of the mechanical arm and an entire body of the support robot.

Operation 1205: Perform compliance control on whole-body joints.

Joint acceleration corresponding to the whole-body joints of the support robot may be obtained based on the force conditions of each joint, so as to perform compliance control.

In one embodiment, based on perceiving a support requirement of the target object, the support robot may be controlled to follow the target object and perform the support task. For example, when an intention of walking support of the target object is perceived, the support robot may be controlled to update the target movement location in real time based on a relative distance between a pose sensor and the target object. Then, based on the updated target movement location, the support robot is controlled to move toward the target object, such that the support robot follows the target object to perform a support task. In a process of following the target object to move, the support robot may detect the obstacle through the target sensor. When the obstacle is identified within a preset angle range, feature extraction may be performed on data obtained by the target sensor, so as to determine an outline of the obstacle and then calculate a target size of the obstacle. Specifically, the pose sensor (for example, a laser radar) may be used to obtain environmental data of a surrounding environment. Point cloud segmentation is performed on the environmental data to identify key features such as the obstacle and the ground. The segmented point cloud data is then clustered to form “clusters” of the obstacle, such that a size of the obstacle may be further analyzed. Or, a visual sensor (for example, a depth camera) may be used to obtain a depth image of a current environment. Distance data of the obstacle is determined by calculating a depth of field of the depth image, and a pre-trained neural network model is used to identify the distance data and estimate the size of the obstacle. More accurate environmental data may be obtained by combining data from a plurality of sensors. For example, sensor data obtained from the pose sensor and the visual sensor may be imported into a corrector or a particle corrector for multi-source data fusion analysis, to determine the size of the obstacle. The target size of the obstacle is compared with a preset size range. If the target size of the obstacle falls beyond the preset size range, the obstacle may interfere with a movement path of the support robot, thus affecting support safety. Thus, the support robot needs to be controlled to avoid the obstacle.

In one embodiment, the target sensor such as the pose sensor and/or the visual sensor arranged on the support robot may detect a second distance between the support robot and the obstacle. When the second distance is less than or equal to a preset distance threshold, it may be determined that the obstacle may affect movement paths of the support robot and the target object. Thus, the support robot may be controlled to avoid the obstacle, and meanwhile, compliance control may be performed on the mechanical arm of the support robot to provide information feedback (such as application of an external force, and transmission of a sound prompt) for the target object to guide the target object to avoid the obstacle.

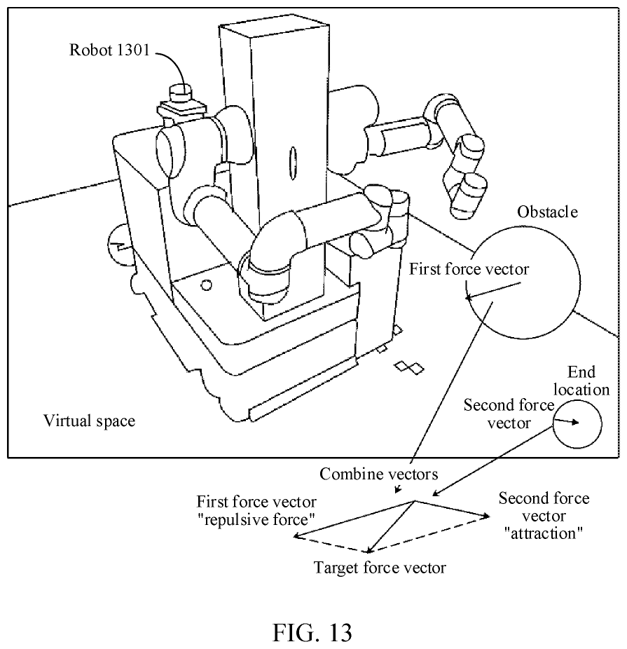

In one embodiment, with reference to FIG. 13, FIG. 13 is a schematic diagram of obstacle avoidance of a support robot according to an embodiment of this application. In a case of determining that an obstacle exists to affect a movement path of the support robot 1301, a virtual space may be created, and sensor data perceived by a target sensor of the support robot may be mapped to the virtual space. Thus, an obstacle location of the obstacle and an end location of the movement path of the support robot may be represented in the virtual space. The obstacle and the end location may be modeled as spheres. Based on the obstacle location and a corresponding obstacle mass of the obstacle, a first force vector, namely a repulsive force of the obstacle, of the obstacle may be determined. The first force vector is configured for guiding the support robot to move away from the obstacle location. Based on the end location and a corresponding preset mass, a second force vector of the end location may be determined, and the second force vector is configured for guiding the support robot to move toward the end location. The first force vector decreases as a second distance increases, while the second force vector decreases as a distance between a current location of the support robot and the end location increases. The first force vector and the second force vector are combined to obtain a target force vector. Specifically, the two vectors may be added or weighted and added to obtain the target force vector. A velocity and a direction of the support robot may be controlled according to the target force vector, such that the support robot moves toward the set end location while avoiding the obstacle.

When second distances between a plurality of obstacles and the support robot are less than or equal to a preset distance threshold, the plurality of obstacles and corresponding obstacle locations may be determined in the virtual space, and a first force vector corresponding to each of the obstacles is obtained. In this way, all the first force vectors and the second force vector may be combined to obtain the target force vectors.

In one embodiment, in a process of supporting the target object, the target sensor may be used to detect changes in an environment around the support robot in real time, so as to respond to emergency events such as environmental changes and ensure safety of the user. For example, in a process of supporting the target object to cross a zebra crossing, the support robot may perceive and identify dynamic obstacles such as vehicles and pedestrians and static obstacles such as road curbs and flower beds in a surrounding environment, and then the support robot may guide the target object to adjust a walking velocity, pause walking, or change a walking path to avoid potential collisions.

In one embodiment, tactile sensors each include a plurality of tactile units. The plurality of tactile units may be evenly distributed on a surface of a mechanical arm. The tactile sensors may collect external force data in real time. Based on detection principles of different tactile sensors, whether the tactile sensors are triggered may be determined through resistance changes, capacitance changes, piezoelectric effects, etc. When the tactile sensors detect that an external force is applied to the mechanical arm, electrical signals of the tactile units may change. The signals may be converted to identifiable external force data, and meanwhile, which tactile units are activated may be analyzed, such that an activated quantity of the tactile units is determined based on the external force data. Specifically, a sensitivity level or an activation threshold may be set to determine whether a tactile unit is in an activated state. When the applied external force exceeds the sensitivity level or activation threshold of the tactile unit, the tactile unit may be determined to be in an activated state. When the tactile sensors detect that an external force is applied to the mechanical arm, the tactile sensors may continuously obtain the external force data. When the detected external force data indicates that the currently applied external force is greater than or equal to an external force threshold and the activated quantity is greater than a preset quantity threshold, it may be determined that the target object is currently engaged in large-area force interaction with the mechanical arm. Thus, it may be determined that the target object is currently supported by the support robot, or that the target object currently experiences an emergency, such as a case that a center of gravity becomes unstable. Accordingly, compliance control may be performed on the support robot to adjust a target joint location and target joint acceleration of the mechanical arm, so as to match a posture of the target object.

In one embodiment, when the external force data indicates that the external force applied to the tactile sensors is greater than or equal to the external force threshold and the activated quantity is less than the preset quantity threshold, it may be determined that the target object currently interacts with the mechanical arm, and current support stability is low. If a current posture of the support robot is changed, the target object is likely to lose support balance. Thus, the support robot may be controlled to move to the target movement location or the mechanical arm may be controlled to move to the target joint location according to a preset control policy, and compliance control of the support robot is not required.

In one embodiment, when the external force data indicates that a change value of the external force applied to the tactile sensors is greater than or equal to a first external force change threshold within a first preset period and the change value of the external force is less than a second external force change threshold within a second preset period after the first preset period, it may be determined that the target object is currently engaged in force interaction with the mechanical arm, and a current support posture of the support robot and a supported posture of the target object are stable. Thus, compliance control may be performed on the support robot.

The control method for a support robot according to an embodiment of this application will be described in detail below.

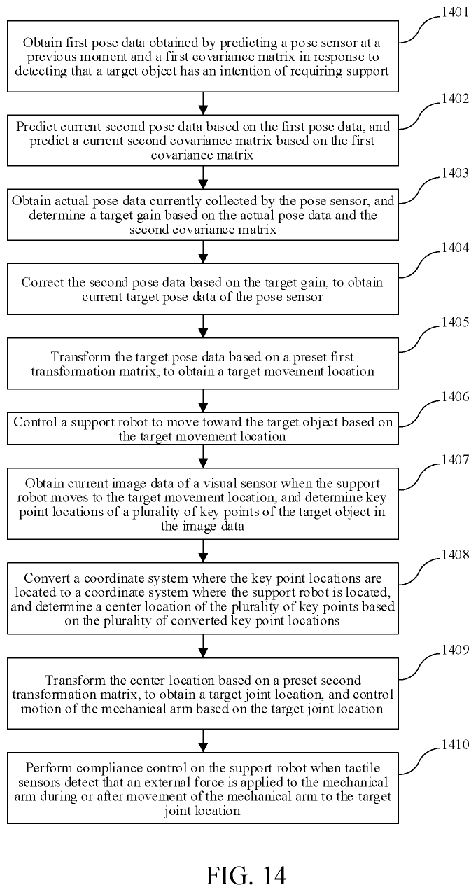

With reference to FIG. 14, FIG. 14 is an entire schematic flowchart of a control method according to an embodiment of this application. The control method may be performed by a terminal. The control method includes, but is not limited to, the following operation 1401 to operation 1410.

Operation 1401: Obtain first pose data obtained by predicting a pose sensor at a previous moment and a first covariance matrix in response to detecting that a target object has an intention to request support.

Operation 1402: Predict current second pose data based on the first pose data, and predict a current second covariance matrix based on the first covariance matrix.

Operation 1403: Obtain actual pose data currently collected by the pose sensor, and determine a target gain based on the actual pose data and the second covariance matrix.

Operation 1404: Correct the second pose data based on the target gain, to obtain current target pose data of the pose sensor.

Operation 1405: Transform the target pose data based on a preset first transformation matrix, to obtain a target movement location.

Operation 1406: Control the support robot to move toward the target object based on the target movement location.

Operation 1407: Obtain current image data of a visual sensor when the support robot moves to the target movement location, and determine key point locations of a plurality of key points of the target object in the image data.

Operation 1408: Convert a coordinate system where the key point locations are located to a coordinate system where the support robot is located, and determine a center location of the plurality of key points based on the plurality of converted key point locations.

Operation 1409: Transform the center location based on a preset second transformation matrix, to obtain a target joint location, and control motion of a mechanical arm based on the target joint location.

In the operation, the target movement location and the target joint location are both determined according to relative locations between the target object and a target sensor.

Operation 1410: Perform compliance control on the support robot when tactile sensors detect that an external force is applied to the mechanical arm during or after movement of the mechanical arm to the target joint location.

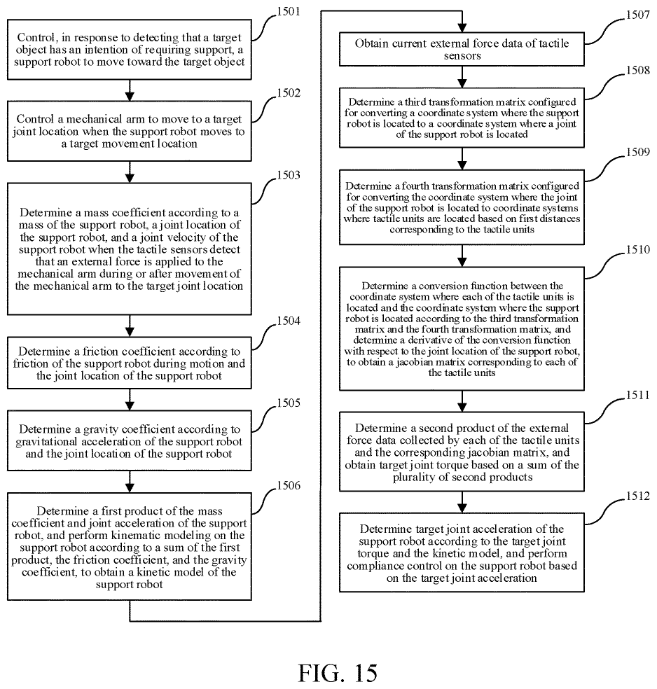

With reference to FIG. 15, FIG. 15 is an entire schematic flowchart of a control method according to an embodiment of this application. The control method may be performed by a terminal. The control method includes, but is not limited to, the following operation 1501 to operation 1512.

Operation 1501: Control, in response to detecting that a target object has an intention to request support, the support robot to move toward the target object.

Operation 1502: Control a mechanical arm to move to a target joint location when the support robot moves to a target movement location.

In the operation, the target movement location and the target joint location are both determined according to relative locations between the target object and a target sensor.

Operation 1503: Determine a mass coefficient according to a mass of the support robot, a joint location of the support robot, and a joint velocity of the support robot when tactile sensors detect that an external force is applied to the mechanical arm during or after movement of the mechanical arm to the target joint location.

Operation 1504: Determine a friction coefficient according to friction of the support robot during motion and the joint location of the support robot.

Operation 1505: Determine a gravity coefficient according to gravitational acceleration of the support robot and the joint location of the support robot.

Operation 1506: Determine a first product of the mass coefficient and joint acceleration of the support robot, and perform kinematic modeling on the support robot according to a sum of the first product, the friction coefficient, and the gravity coefficient, to obtain a kinetic model of the support robot.

In the operation, the kinetic model is configured for indicating a relationship between joint torque of the support robot and the joint acceleration of the support robot.

Operation 1507: Obtain current external force data of the tactile sensors.

Operation 1508: Determine a third transformation matrix configured for converting a coordinate system where the support robot is located to a coordinate system where a joint of the support robot is located.

Operation 1509: Determine a fourth transformation matrix configured for converting the coordinate system where the joint of the support robot is located to coordinate systems where tactile units are located based on first distances corresponding to the tactile units.

In the operation, the plurality of tactile units are distributed on the mechanical arm in a cylindrical shape, and the first distance between any two adjacent tactile units is equal.

Operation 1510: Determine a conversion function between the coordinate system where each of the tactile units is located and the coordinate system where the support robot is located according to the third transformation matrix and the fourth transformation matrix, and determine a derivative of the conversion function with respect to the joint location of the support robot, to obtain a Jacobian matrix corresponding to each of the tactile units.

Operation 1511: Determine a second product of the external force data collected by each of the tactile units and the corresponding Jacobian matrix, and obtain target joint torque based on a sum of the plurality of second products.

Operation 1512: Determine target joint acceleration of the support robot according to the target joint torque and the kinetic model, and perform compliance control on the support robot based on the target joint acceleration.

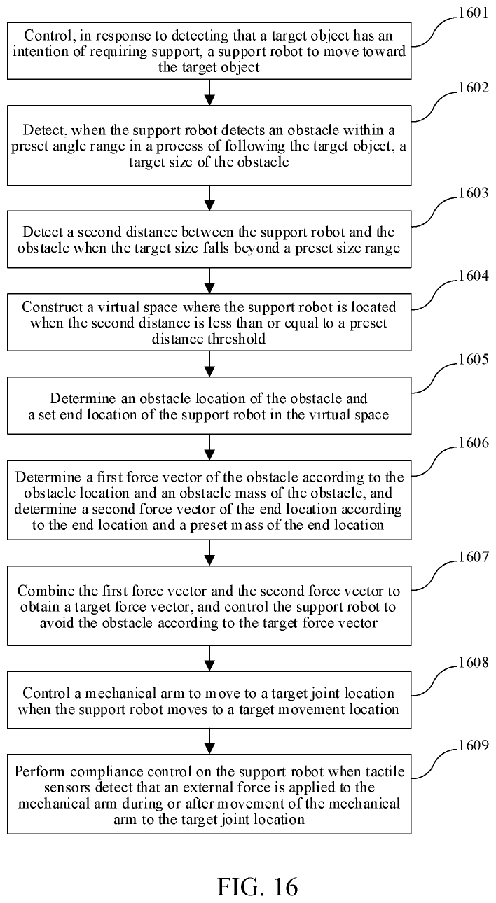

With reference to FIG. 16, FIG. 16 is an entire schematic flowchart of a control method according to an embodiment of this application. The control method may be performed by a terminal. The control method includes, but is not limited to, the following operation 1601 to operation 1609.

Operation 1601: Control, in response to detecting that a target object has an intention to request support, the support robot to move toward the target object.

Operation 1602: Detect, when the support robot detects an obstacle within a preset angle range in a process of following the target object, a target size of the obstacle.

Operation 1603: Detect a second distance between the support robot and the obstacle when the target size falls beyond a preset size range.

Operation 1604: Construct a virtual space where the support robot is located when the second distance is less than or equal to a preset distance threshold.

Operation 1605: Determine an obstacle location of the obstacle and a set end location of the support robot in the virtual space.

Operation 1606: Determine a first force vector of the obstacle according to the obstacle location and an obstacle mass of the obstacle, and determine a second force vector of the end location according to the end location and a preset mass of the end location.

Operation 1607: Combine the first force vector and the second force vector to obtain a target force vector, and control the support robot to avoid the obstacle according to the target force vector.

Operation 1608: Control a mechanical arm to move to a target joint location when the support robot moves to a target movement location.

In the operation, the target movement location and the target joint location are both determined according to relative locations between the target object and a target sensor.

Operation 1609: Perform compliance control on the support robot when tactile sensors detect that an external force is applied to the mechanical arm during or after movement of the mechanical arm to the target joint location.

Although the operations in each of the flowcharts are displayed sequentially according to arrows, these operations are not necessarily performed in the sequence indicated by the arrows. Unless otherwise explicitly specified in the embodiment, performing of these operations is not strictly limited by the sequence, and these operations may be performed in other sequences. Moreover, at least part of the operations in the above flowcharts may include a plurality of operations or a plurality of stages. These operations or stages are not necessarily performed at the same time, but may be performed at different times. These operations or stages are not necessarily performed sequentially, but may be performed in turn or alternately with other operations or at least part of operations or stages of other operations.

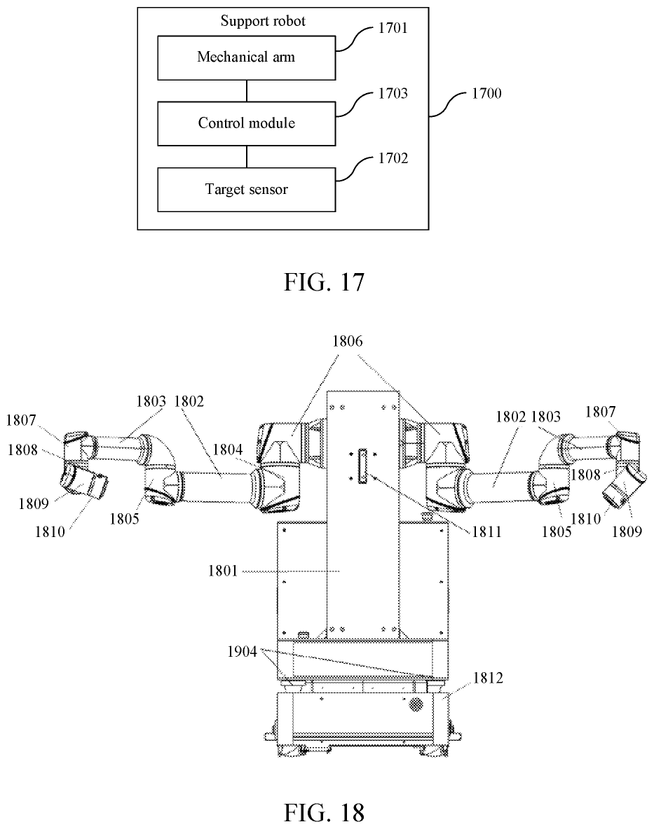

With reference to FIG. 17, FIG. 17 is a schematic structural diagram of a support robot according to an embodiment of this application. The support robot 1700 includes:
a mechanical arm 1701, provided with tactile sensors;
a target sensor 1702, configured to perform object perception; and
a control module 1703, configured to control, in response to detecting that a target object has an intention to request support, the support robot 1700 to move toward the target object, control the mechanical arm 1701 to move to a target joint location when the support robot 1700 moves to a target movement location, and perform compliance control on the support robot 1700 when the tactile sensors detect that an external force is applied to the mechanical arm during movement of the mechanical arm 1701 to the target joint location or after movement of the mechanical arm 1701 to the target joint location. The target movement location and the target joint location are both determined according to relative locations between the target object and the target sensor 1702.

In one embodiment, the control module 1703 is further configured to:
obtain current target pose data of the pose sensor, and transform the target pose data based on a preset first transformation matrix, to obtain the target movement location; and
control the support robot 1700 to move toward the target object based on the target movement location.

In one embodiment, the control module 1703 is further configured to:
obtain first pose data obtained by predicting the pose sensor at a previous moment and a first covariance matrix, predict current second pose data based on the first pose data, and predict a current second covariance matrix based on the first covariance matrix;
obtain actual pose data currently collected by the pose sensor, and determine a target gain based on the actual pose data and the second covariance matrix; and
correct the second pose data based on the target gain, to obtain the current target pose data of the pose sensor.

In one embodiment, the control module 1703 is further configured to:
obtain current image data of the visual sensor, and determine key point locations of a plurality of key points of the target object in the image data;
convert a coordinate system where the key point locations are located to a coordinate system where the support robot 1700 is located, and determine a center location of the plurality of key points based on the plurality of converted key point locations; and
transform the center location based on a preset second transformation matrix, to obtain the target joint location, and control motion of the mechanical arm 1701 based on the target joint location.

In one embodiment, the control module 1703 is further configured to:
perform parameter calibration on the visual sensor, to obtain an intrinsic matrix of the visual sensor;
determine a mounting location of the visual sensor in the support robot 1700, and determine an extrinsic matrix of the visual sensor according to the mounting location; and
convert the coordinate system where the key point locations are located to the coordinate system where the support robot is located based on the intrinsic matrix and the extrinsic matrix.

In one embodiment, the control module 1703 is further configured to:
perform posture identification on the target object according to each of the key points, a result of the posture identification including a case that the target object has the intention to request support or that the target object has no intention to request support.

In one embodiment, the control module 1703 is further configured to:
perform kinematic modeling on the support robot 1700, to obtain a kinetic model of the support robot 1700, the kinetic model being configured for indicating a relationship between joint torque of the support robot 1700 and joint acceleration of the support robot 1700;
obtain current external force data of the tactile sensors, and convert the external force data, to obtain target joint torque; and
determine target joint acceleration of the support robot 1700 according to the target joint torque and the kinetic model, and perform compliance control on the support robot 1700 based on the target joint acceleration.

In one embodiment, the control module 1703 is further configured to:
determine a mass coefficient according to a mass of the support robot 1700, a joint location of the support robot 1700, and a joint velocity of the support robot 1700;
determine a friction coefficient according to friction of the support robot 1700 during motion and the joint location of the support robot 1700;
determine a gravity coefficient according to gravitational acceleration of the support robot 1700 and the joint location of the support robot 1700; and
determine a first product of the mass coefficient and the joint acceleration of the support robot 1700, and perform kinematic modeling on the support robot 1700 according to a sum of the first product, the friction coefficient, and the gravity coefficient, to obtain the kinetic model of the support robot 1700.

In one embodiment, the control module 1703 is further configured to:
determine a third transformation matrix configured for converting the coordinate system where the support robot 1700 is located to a coordinate system where a joint of the support robot 1700 is located, and determine a fourth transformation matrix configured for converting the coordinate system where the joint of the support robot 1700 is located to coordinate systems where tactile units are located;
determine a conversion function between the coordinate system where each of the tactile units is located and the coordinate system where the support robot 1700 is located according to the third transformation matrix and the fourth transformation matrix, and determine a derivative of the conversion function with respect to the joint location of the support robot 1700, to obtain a Jacobian matrix corresponding to each of the tactile units; and
determine a second product of the external force data collected by each of the tactile units and the corresponding Jacobian matrix, and obtain target joint torque based on a sum of the plurality of second products.

In one embodiment, the plurality of tactile units are distributed on the mechanical arm 1701 in a cylindrical shape, and a first distance between any two adjacent tactile units is equal. The control module 1703 is further configured to:

determine the fourth transformation matrix configured for converting the coordinate system where the joint of the support robot 1700 is located to the coordinate systems where the tactile units are located based on the first distances corresponding to the tactile units.

In one embodiment, the control module 1703 is further configured to:
detect, when the support robot 1700 detects an obstacle within a preset angle range in a process of following the target object, a target size of the obstacle; and
control the support robot 1700 to avoid the obstacle when the target size falls beyond a preset size range.

In one embodiment, the control module 1703 is further configured to:
detect a second distance between the support robot 1700 and the obstacle, and construct a virtual space where the support robot 1700 is located when the second distance is less than or equal to a preset distance threshold;
determine an obstacle location of the obstacle and a set end location of the support robot 1700 in the virtual space;
determine a first force vector of the obstacle according to the obstacle location and an obstacle mass of the obstacle, and determine a second force vector of the end location according to the end location and a preset mass of the end location; and
combine the first force vector and the second force vector to obtain a target force vector, and control the support robot 1700 to avoid the obstacle according to the target force vector.

In one embodiment, the tactile sensors are each provided with the plurality of tactile units, and the control module 1703 is further configured to:
obtain current external force data of the tactile sensors when the tactile sensors detect that the external force is applied to the mechanical arm, and determine an activated quantity of the tactile units according to the external force data; and
perform compliance control on the support robot 1700 when the external force data indicates that the external force applied to the tactile sensors is greater than or equal to an external force threshold and the activated quantity is greater than or equal to a preset quantity threshold.

In one embodiment, with reference to FIG. 18, FIG. 18 is a schematic structural diagram of a support robot 1700 according to an embodiment of this application. As shown in FIG. 18, the support robot 1700 includes a main torso 1801. A mechanical arm 1701 includes a first sub-arm 1802 and a second sub-arm 1803. One end of the first sub-arm 1802 is movably connected to the main torso 1801, and the other end of the first sub-arm 1802 is movably connected to the second sub-arm 1803. The first sub-arm 1802 and the second sub-arm 1803 are both provided with tactile sensors. That is, the first sub-arm 1802 is movable relative to the main torso 1801, and the second sub-arm 1803 is movable relative to the first sub-arm 1802. The first sub-arm 1802 may be used as a main part of the mechanical arm 1701, and may bear a greater force relative to the second sub-arm 1803, so as to facilitate supporting and assisting of a user. The second sub-arm 1803 acts as an extension of the first sub-arm 1802, and can perform more complex and detailed actions, such as fine adjustment of a support strength or direction, relative to the first sub-arm 1802. In addition, a connecting rod length of the second sub-arm 1803 may be less than that of the first sub-arm 1802, such that motion inertia of the second sub-arm 1803 is reduced, to implement more accurate motion control. Thus, the first sub-arm 1802 and the second sub-arm 1803 are movably connected to each other in a multistage mode, such that a broader motion range of the mechanical arm 1701 can be provided, a function of a body limb can be better imitated, a target object is assisted in movement, and support and protection are provided. The tactile sensors may be arranged on the first sub-arm 1802 and the second sub-arm 1803, respectively, such that more comprehensive external force data can be obtained, and further a posture of the target object can be identified more accurately. In this way, compliance control is performed on the support robot 1700.

In one embodiment, two ends of the first sub-arm 1802 are connected to a first joint part 1804 and a second joint part 1805, respectively. The first joint part 1804 is connected to a third joint part 1806 through a first connecting shaft. The third joint part 1806 is connected to the main torso 1801 through a second connecting shaft. One end of the second sub-arm 1803 is connected to the second joint part 1805 through a third connecting shaft, and the other end of the second sub-arm 1803 is connected to a fourth joint part 1807 through a fourth connecting shaft. The fourth joint part 1807 is connected to a fifth joint part 1808 through a fifth connecting shaft. The fifth joint part 1808 is connected to a sixth joint part 1809 through a sixth connecting shaft. The sixth joint part 1809 is connected to an end actuator 1810. As shown in FIG. 26, the mechanical arm 1701 of the support robot 1700 may include 6 joint parts, so as to achieve 6 degrees of freedom. The third joint part 1806 may rotate relative to the main torso 1801 about the second connecting shaft. The first joint part 1804 may rotate relative to the third joint part 1806 about the first connecting shaft. In this way, the first sub-arm 1802 and the second joint part 1805 may synchronously move relative to the third joint part 1806. The second sub-arm 1803 may rotate relative to the second joint part 1805 about the third connecting shaft. The fourth joint part 1807 may rotate relative to the second sub-arm 1803 about the fourth connecting shaft. The fifth joint part 1808 may rotate relative to the fourth joint part 1807 about the fifth connecting shaft. The sixth joint part 1809 may rotate relative to the fifth joint part 1808 about the sixth connecting shaft.

In one embodiment, the sixth joint part 1809 is connected to the end actuator 1810, and the end actuator 1810 is detachably mounted on the sixth joint part 1809. The end actuator 1810 may be a robot gripper, which may assist a user in transferring articles, and for example, transferring heavy objects, backpacks, crutches, etc. Or, the end actuator 1810 may be a safety restraint apparatus, such as a safety belt, which may improve stability and safety in a process of supporting the target object to move. Or, the end actuator 1810 may be a support handle or a handrail, thus facilitating gripping of the target object, so as to provide stable support for the target object. Or, the end actuator 1810 may be a task controller configured to set a support task, and the task controller may be communicatively connected to the control module 1703. The control module 1703 may control the support robot 1700 based on the support task set and triggered by the task controller. For example, if an original support task is supporting the target object to walk, when the support robot reaches a location (for example, a location beside a seat) designated by the target object, the task controller of the end actuator 1810 may be triggered to reset the support task to a task of supporting the target object to sit down, such that the control module 1703 may change the support task and control the support robot 1700 to support the target object to sit down on the seat.

In addition, the support robot 1700 may be provided with a plurality of mechanical arms 1701. As shown in FIG. 18, the support robot 1700 may be provided with two mechanical arms 1701. Moreover, to reduce collisions between the plurality of mechanical arms 1701 and implement adjustment in different directions, the mechanical arms 1701 may be mounted on two sides of the main torso 1801, respectively.

As shown in FIG. 18, the support robot 1700 further includes a visual sensor 1811, a pose sensor, and a base 1812 for movement. The visual sensor 1811 may be mounted on a front side of the main torso 1801, and the visual sensor 1811 may be located between the mechanical arms 1701 on the two sides. In this way, a wider field angle can be obtained to capture image data to identify a body posture. The pose sensor may be mounted on a front side of the base 1812, to perceive a condition of an environment where the support robot 1700 is currently located, such as a location of the target object and a location of the obstacle. When a plurality of pose sensors are provided, the pose sensors may be arranged on peripheral side walls of the base 1812, respectively, to improve a perception range, such that more accurate environmental data is obtained.

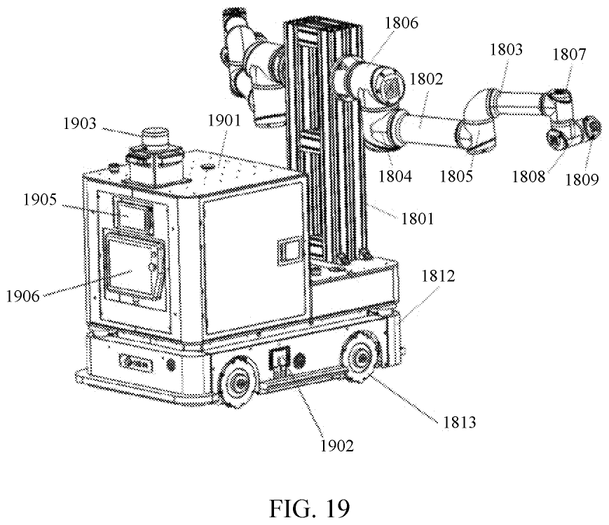

As shown in FIG. 19, FIG. 19 is a schematic structural diagram of a support robot 1700 according to an embodiment of this application from another viewing angle. A pose sensor, a control cabinet 1901, an antenna 1902, a base display screen 1905 configured to interactively display a state of the base 1812, and a control display screen 1906 configured to interactively display a state of the mechanical arm 1701 may be arranged in the base 1812. The base display screen 1905 and the control display screen 1906 are mounted on an outer side of the control cabinet 1901, to facilitate interaction with the user. The pose sensor may include a three-dimensional laser radar 1903 configured to detect an obstacle, and a two-dimensional laser radar 1904 configured to detect a location of a target object and an obstacle location. The two-dimensional laser radar 1904 may be mounted on a side wall of the base 1812. The three-dimensional laser radar 1903 may be mounted above the control cabinet 1901. The antenna 1902 may be mounted on one side of the base 1812 and is closer to the control cabinet 1901.

As shown in FIG. 19, the base 1812 may be a Mecanum mobile platform. In this case, a joint at a lower limb part of the support robot 1700 may be a movable connection mechanism between an omnidirectional wheel 1813 and the base 1812. The Mecanum mobile platform is a mobile robot platform. The Mecanum mobile platform uses a Mecanum wheel (also known as a Swiss wheel) to achieve omnidirectional movement. The platform can move in any direction on a horizontal plane without steering, thus greatly improving mobility and flexibility of the robot. The Mecanum wheel is a large wheel formed by a plurality of small rollers. The small rollers form an angle (typically 45 degrees) with an axis of the large wheel. When the large wheel rotates, the small rollers may roll to allow the large wheel to move in any direction on the horizontal plane without changing an orientation of the wheel. Each Mecanum wheel may be independently driven, and a complex movement track may be implemented by controlling a velocity and a direction of each wheel.

The main torso 1801 may be located on a front side of the control cabinet 1901. As a center of gravity of the support robot 1700 is moved forward due to influence of weights of the mechanical arm 1701 and the main torso 1801, the control cabinet 1901 may be placed on a rear side of the main torso 1801, and a weight is added to the base 1812 to balance a location of the center of gravity of the support robot 1700, thus improving movement stability of the support robot 1700.

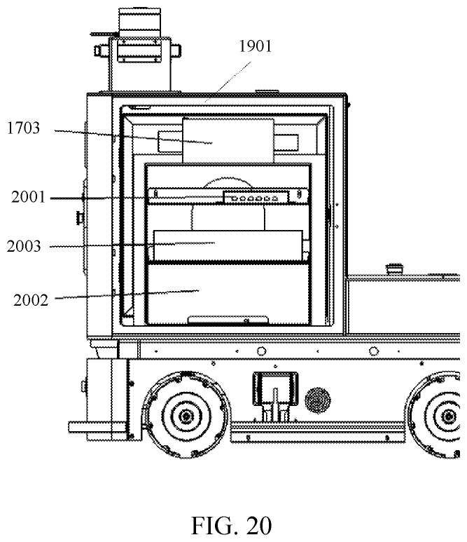

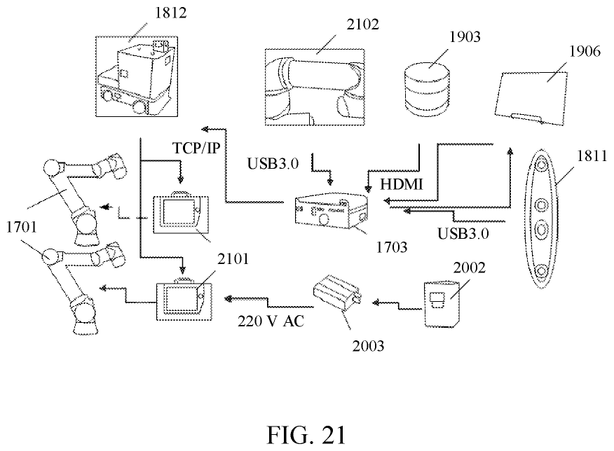

As shown in FIG. 20, FIG. 20 is a schematic diagram of an internal structure of a control cabinet 1901 of a support robot 1700 according to an embodiment of this application. The support robot 1700 further includes a switch 2001 connected to an antenna 1902 and a control module 1703 (e.g., a control circuit) separately, a storage battery 2002 for power supply, and an inverter 2003 configured to convert voltage of the storage battery 2002 to supply power. The control module 1703, the switch 2001, the storage battery 2002, and the inverter 2003 are mounted in the control cabinet 1901. The control module 1703 may perform data interaction with a server through the switch 2001 and the antenna 1902, and for example, upload sensor data to the server or download an updated algorithm program from the server.

As shown in FIG. 21, FIG. 21 is a schematic diagram of structural connection of a support robot 1700 according to an embodiment of this application. The storage battery 2002 is connected to the inverter 2003, so as to convert a voltage of 48 V of the storage battery 2002 to an alternating current voltage of 221 V, to supply an electric load of the support robot 1700. A control module 1703 may be communicatively connected to a tactile sensor, a pose sensor (including a three-dimensional laser radar 1903 and a two-dimensional laser radar 1904), a visual sensor 1811, a mechanical arm control cabinet 2101, a base display screen 1905, and a control display screen 1906 separately. In this way, the control module 1703 may obtain data from each sensor and interaction data from each display screen. The control module 1703 may generate control instructions based on the obtained data and transmit the control instructions to the mechanical arm control cabinet 2101. Then, the mechanical arm control cabinet 2101 controls a mechanical arm 1701 and a base 1812. Specifically, the control module 1703 may be connected to various parts in different data transmission modes. For example, the control module 1703 may perform data transmission with the mechanical arm 1701 and the base 1812 through a transmission control protocol/internet protocol (TCP/IP), may perform data transmission with the tactile sensor and the visual sensor 1811 through a universal serial bus (USB) 3.0 transmission protocol, or may perform data transmission with the pose sensor, the base display screen 1905, and the control display screen through a high-definition multimedia interface (HDMI) transmission protocol.

The control module 1703 may be an industrial personal computer, and is configured to perform the control method according to the embodiments. In response to detecting that the target object has the intention to request support, the support robot is controlled to move toward the target object, and the mechanical arm is controlled to move to the target joint location when the support robot moves to the target movement location. The target movement location and the target joint location are both determined according to the relative locations between the target object and the target sensor. In this way, a state of the target object can be perceived, and a support task can be automatically performed according to the state of the target object. Based on this, compliance control is performed on the mechanical arm when the tactile sensors detect that the external force is applied to the mechanical arm during or after movement of the mechanical arm to the target joint location, such that the mechanical arm can follow a posture of the target object. Thus, support comfort is improved. In view of this, the control method provided by this application can perform diversified interaction with the target object, such that the support robot can automatically perform a support task, thus improving performance accuracy and efficiency of the support task by the support robot.

An embodiment of this application further provides an electronic device, including a memory and a processor, the memory storing a computer program, and the processor, when executing the computer program, implementing the control method according to the embodiments.

An embodiment of this application further provides a computer-readable storage medium. The computer-readable storage medium is configured to store a computer program. The computer program is configured for performing the control method according to each of the embodiments.

An embodiment of this application further provides a computer program product. The computer program product includes a computer program. The computer program is stored in a computer-readable storage medium. A processor of a computer device reads the computer program from the computer-readable storage medium. The processor executes the computer program, to cause the computer device to perform the control method.

In the description and the accompanying drawings of this application, the terms such as “first”, “second”, “third”, and “fourth” (if existent) are intended to distinguish between similar objects, but do not necessarily indicate a specific sequence or order. Data used in this way is interchangeable in a suitable case, such that the embodiments of this application described can, for example, be implemented in a sequence other than those illustrated or described herein. In addition, the terms “comprise”, “include”, and “have”, and their any variants are intended to cover non-exclusive inclusion. For example, a process, a method, a system, a product, or an apparatus that encompasses a series of steps or units is not necessarily limited to those steps or units expressly listed, but may include other steps or units not expressly listed or inherent to the process, the method, the product, or the apparatus.

In this application, “at least one” means one or more, and “a plurality of” means two or more. The term “and/or” is configured for describing an association relationship between associated objects and indicates that three association relationships may exist. For example, “A and/or B” may indicate that only A exists, only B exists, and both A and B exist. A and B may be singular or plural. The character “/” generally indicates an “or” relationship between the associated objects. “At least one of the following items” or a similar expression means any combination of these items, including a single item or any combination of a plurality of items. For example, at least one item of a, b, or c may indicate a, b, c, “a and b”, “a and c”, “b and c”, or “a, b, and c”, where a, b, and c may be singular or plural.

In the description in the embodiments of this application, the term “a plurality of” indicates two or more, the terms such as “greater than”, “less than”, and “exceed” are interpreted as excluding the present number, and the terms such as “above”, “below”, and “within” are interpreted as including the present number.

In several embodiments provided in this application, the disclosed system, apparatus, and method may be implemented in other modes. For example, the described apparatus embodiments are merely exemplary. For example, unit division is merely logical function division and may be other division in actual implementation. For example, a plurality of units or components may be combined or integrated into another system, or some features may be ignored or not performed. In addition, the displayed or discussed mutual couplings, direct couplings or communication connections may be implemented through some interfaces. The indirect couplings or communication connections between the apparatuses or units may be implemented in electronic, mechanical, or other forms.

The units described as separate parts may be physically separate or not, and the parts displayed as units may be physical units or not, may be located at one location, or may be distributed on a plurality of network units. Some or all of the units may be selected according to actual needs to achieve objectives of solutions of the embodiments.

In addition, functional units in the embodiments of this application may be integrated into one processing unit, each of the units may exist alone physically, or two or more units may be integrated into one unit. The integrated unit may be implemented in a form of hardware, or may be implemented in a form of a software functional unit.

The integrated unit may be stored in a computer-readable storage medium if implemented in the form of a software functional unit and sold or used as an independent product. Based on such an understanding, the technical solutions of this application essentially, or the part contributing to the related art, or all or some of the technical solutions may be implemented in a form of a software product. The computer software product is stored in a storage medium, and includes a plurality of instructions for instructing a computer apparatus (which may be a personal computer, a server, a network apparatus, etc.) to perform all or some of the steps of methods in the embodiments of this application. The storage medium includes: a USB flash disk, a mobile hard disk, a read-only memory (ROM), a random access memory (RAM), a magnetic disk, an optical disk, and other media capable of storing program codes.

Various implementations according to the embodiments of this application may be combined in different modes to form other embodiments, so as to achieve different technical effects.

Embodiments of this application are described in detail above, but this application is not limited to the implementations. A person skilled in the art can further make various equivalent variations or replacements without departing from the shared condition of the spirit of this application, and these equivalent variations or replacements fall within the scope defined by the claims of this application.

What is claimed is:

1. A control method for a support robot, performed by an electronic device, the support robot comprising a mechanical arm and a target sensor configured to perform object perception, the mechanical arm being provided with tactile sensors, and the control method comprising:
controlling, in response to detecting that a target object has an intention to request support, the support robot to move toward the target object;
controlling the mechanical arm to move to a target joint location when the support robot moves to a target movement location, the target movement location and the target joint location being determined according to relative locations between the target object and the target sensor; and
performing compliance control on the support robot when the tactile sensors detect that an external force is applied to the mechanical arm during or after movement of the mechanical arm to the target joint location.

2. The control method according to claim 1, wherein types of the target sensor comprise a visual sensor and a pose sensor, the target movement location is determined according to relative locations between the target object and the pose sensor, and the target joint location is determined according to relative locations between the target object and the visual sensor.

3. The control method according to claim 2, wherein the controlling the support robot to move toward the target object comprises:
obtaining current target pose data of the pose sensor;
transforming the target pose data based on a first transformation matrix, to obtain the target movement location; and
controlling the support robot to move toward the target object based on the target movement location.

4. The control method according to claim 3, wherein the obtaining current target pose data of the pose sensor comprises:
obtaining first pose data and a first covariance matrix by predicting the pose sensor at a previous moment;
predicting second pose data based on the first pose data, and predicting a second covariance matrix at a current time based on the first covariance matrix;
obtaining pose data currently collected by the pose sensor;
determining a target gain based on the pose data and the second covariance matrix; and
correcting the second pose data based on the target gain, to obtain the current target pose data of the pose sensor.

5. The control method according to claim 2, wherein the controlling the mechanical arm to move to a target joint location comprises:
obtaining current image data of the visual sensor;
determining key point locations of a plurality of key points of the target object in the image data;
converting a coordinate system where the key point locations are located to a coordinate system where the support robot is located;
determining a center location of the plurality of key points based on the plurality of converted key point locations; and
transforming the center location based on a preset second transformation matrix, to obtain the target joint location, and controlling motion of the mechanical arm based on the target joint location.

6. The control method according to claim 5, wherein the converting a coordinate system where the key point locations are located to a coordinate system where the support robot is located comprises:
performing parameter calibration on the visual sensor, to obtain an intrinsic matrix of the visual sensor;
determining a mounting location of the visual sensor in the support robot, and determining an extrinsic matrix of the visual sensor according to the mounting location; and
converting the coordinate system where the key point locations are located to the coordinate system where the support robot is located based on the intrinsic matrix and the extrinsic matrix.

7. The control method according to claim 5, wherein before the controlling, in response to detecting that a target object has an intention to request support, the support robot to move toward the target object, the control method further comprises:
performing posture identification on the target object according to each of the key points, a result of the posture identification indicating that the target object has the intention to request support or that the target object has no intention to request support.

8. The control method according to claim 5, wherein before the controlling, in response to detecting that a target object has an intention to request support, the support robot to move toward the target object, the control method further comprises:
detecting voice information of the target object;
performing feature extraction on the voice information, to obtain voice features;
performing classification based on the voice features, to obtain a prediction type of the voice features; and
determining that the target object has the intention to request support according to the prediction type.

9. The control method according to claim 5, wherein before the controlling, in response to detecting that a target object has an intention to request support, the support robot to move toward the target object, the control method further comprises:
detecting, in response to receiving a first signal for the support robot, the first signal, to obtain a detection result; and
determining that the target object has the intention to request support according to the detection result.

10. The control method according to claim 1, wherein the performing compliance control on the support robot comprises:
performing kinematic modeling on the support robot, to obtain a kinetic model of the support robot, the kinetic model being configured for indicating a relationship between joint torque of the support robot and joint acceleration of the support robot;
obtaining current external force data of the tactile sensors, and converting the external force data, to obtain target joint torque;
determining target joint acceleration of the support robot according to the target joint torque and the kinetic model; and
performing compliance control on the support robot based on the target joint acceleration.

11. The control method according to claim 10, wherein the performing kinematic modeling on the support robot, to obtain a kinetic model of the support robot comprises:
determining a mass coefficient according to a mass of the support robot, a joint location of the support robot, and a joint velocity of the support robot;
determining a friction coefficient according to friction of the support robot during motion and the joint location of the support robot;
determining a gravity coefficient according to gravitational acceleration of the support robot and the joint location of the support robot; and
determining a first product of the mass coefficient and the joint acceleration of the support robot; and
performing kinematic modeling on the support robot according to a sum of the first product, the friction coefficient, and the gravity coefficient, to obtain the kinetic model of the support robot.

12. The control method according to claim 10, wherein the tactile sensors are each provided with a plurality of tactile units, and the converting the external force data, to obtain target joint torque comprises:
determining a third transformation matrix configured for converting the coordinate system where the support robot is located to a coordinate system where a joint of the support robot is located;
determining a fourth transformation matrix configured for converting the coordinate system where the joint of the support robot is located to coordinate systems where the tactile units are located;
determining a conversion function between the coordinate system where each of the tactile units is located and the coordinate system where the support robot is located according to the third transformation matrix and the fourth transformation matrix;
determining a derivative of the conversion function with respect to the joint location of the support robot, to obtain a Jacobian matrix corresponding to each of the tactile units; and
determining a second product of the external force data collected by each of the tactile units and the corresponding Jacobian matrix, and obtaining the target joint torque based on a sum of the plurality of second products.

13. The control method according to claim 12, wherein the plurality of tactile units are distributed on the mechanical arm in a cylindrical shape, a first distance between any two adjacent tactile units is equal, and the determining a fourth transformation matrix configured for converting the coordinate system where the joint of the support robot is located to coordinate systems where the tactile units are located comprises:
determining the fourth transformation matrix configured for converting the coordinate system where the joint of the support robot is located to the coordinate systems where the tactile units are located based on the first distances corresponding to the tactile units.

14. The control method according to claim 1, further comprising:
detecting, when the support robot detects an obstacle within a preset angle range in a process of following the target object, a target size of the obstacle; and
controlling the support robot to avoid the obstacle when the target size falls beyond a preset size range.

15. The control method according to claim 14, wherein the controlling the support robot to avoid the obstacle comprises:
detecting a second distance between the support robot and the obstacle;
constructing a virtual space where the support robot is located when the second distance is less than or equal to a preset distance threshold;
determining an obstacle location of the obstacle and a set end location of the support robot in the virtual space;
determining a first force vector of the obstacle according to the obstacle location and an obstacle mass of the obstacle;
determining a second force vector of the end location according to the end location and a preset mass of the end location; and
combining the first force vector and the second force vector to obtain a target force vector, and controlling the support robot to avoid the obstacle according to the target force vector.

16. The control method according to claim 1, wherein the tactile sensors are each provided with the plurality of tactile units, and the performing compliance control on the support robot when the tactile sensors detect that an external force is applied to the mechanical arm comprises:
obtaining current external force data of the tactile sensors when the tactile sensors detect that the external force is applied to the mechanical arm;
determining an activated quantity of the tactile units according to the external force data; and
performing compliance control on the support robot when the external force data indicates that the external force applied to the tactile sensors is greater than or equal to an external force threshold and the activated quantity is greater than or equal to a preset quantity threshold.

17. A support robot, provided with a control circuit, a mechanical arm, and a target sensor configured to perform object perception, the mechanical arm being provided with tactile sensors;
wherein the control circuit being configured to:
control, in response to detecting that a target object has an intention to request support, the support robot to move toward the target object;
control the mechanical arm to move to a target joint location when the support robot moves to a target movement location; and
perform compliance control on the support robot when the tactile sensors detect that an external force is applied to the mechanical arm during or after movement of the mechanical arm to the target joint location; and
wherein the target movement location and the target joint location are determined according to relative locations between the target object and the target sensor.

18. The support robot according to claim 17, wherein
the support robot comprises a main torso, the mechanical arm comprises a first sub-arm and a second sub-arm, one end of the first sub-arm is movably connected to the main torso, the other end of the first sub-arm is movably connected to the second sub-arm, and the first sub-arm and the second sub-arm are both provided with the tactile sensors.

19. The support robot according to claim 18, wherein
two ends of the first sub-arm are connected to a first joint part and a second joint part, respectively, the other end of the first joint part is connected to a third joint part, and the third joint part is connected to the main torso; and
one end of the second sub-arm is connected to the second joint part, the other end of the second sub-arm is connected to a fourth joint part, the fourth joint part is connected to a fifth joint part, the fifth joint part is connected to a sixth joint part, and the sixth joint part is connected to an end actuator.

20. An electronic device, comprising a memory and a processor, the memory storing a computer program, and the processor, when executing the computer program, implementing a control method for a support robot, performed by the electronic device, the support robot comprising a mechanical arm and a target sensor configured to perform object perception, the mechanical arm being provided with tactile sensors, and the control method comprising:
controlling, in response to detecting that a target object has an intention to request support, the support robot to move toward the target object;
controlling the mechanical arm to move to a target joint location when the support robot moves to a target movement location, the target movement location and the target joint location both being determined according to relative locations between the target object and the target sensor; and
performing compliance control on the support robot when the tactile sensors detect that an external force is applied to the mechanical arm during or after a movement of the mechanical arm to the target joint location.
